(19) United States
(12) Patent Application Publication
(10) Pub. No.: US 2026/0271038 A1
(43) Pub. Date: Sep. 10, 2026

(54) SIDELINK TRANSMISSION

(71) Applicant: LENOVO (BEIJING) LIMITED, Beijing (CN)

(72) Inventors: Xin Guo, Beijing (CN); Haipeng Lei, Beijing (CN); Zhennian Sun, Beijing (CN); Xiaodong Yu, Beijing (CN)

(21) Appl. No.: 19/166,081

(22) PCT Filed: Jul. 8, 2023
(86) PCT No.: PCT/CN2023/106451

§ 371 Date: Sep. 17, 2025

(51) Int. Cl. H04W 72/40; H04W 74/0808

(52) U.S. Cl. CPC H04W 72/40; H04W 74/0808

(57) ABSTRACT

Various aspects of the present disclosure relate to sidelink transmission. In a first aspect, a user equipment selects an anchor resource block (RB) set and one or more non-anchor RB sets in a time unit. The user equipment performs a channel access procedure on the anchor RB set and the one or more non-anchor RB sets. Then, the user equipment transmits on at least one of the anchor RB set and the one or more non-anchor RB sets, a sidelink-synchronization signal block (S-SSB). In this way, the performance of the sidelink communication can be enhanced.

### TECHNICAL FIELD

The present disclosure relates to wireless communications, and more specifically to sidelink transmission, for example, in unlicensed spectrum.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

With the technology development, sidelink communications between user equipment (UEs) over a wireless interface can be supported. In sidelink communications, the terminal devices may communicate with each other on unlicensed sidelink (SL-U) resources (e.g., on SL-U channels). Specifically, by means of channel contention procedure or a channel access procedure (for example, a listen before talk, LBT, procedure), a terminal device may initiate a channel occupancy time (COT) on certain resources of sidelink resource pool in unlicensed band. This terminal device initiating the COT may be also referred to as COT initiating UE. If the COT is redundancy to the COT initiating UE (for example, the sidelink, SL, transmission is completed, but there is still remaining COT), the COT initiating UE may share a part of initiated COT (for example, one or more slots) to other terminal devices that may be also referred to as COT responding UEs. In addition, UEs also communicate a sidelink-synchronization signal block (S-SSB) with each other on resources excluded from the above sidelink resource pool, in order to implement the synchronization among UEs.

### SUMMARY

The present disclosure relates to user equipment, base station, processors, methods and medium for sidelink transmission, for example, in unlicensed spectrum.

In a first aspect of the solution, a user equipment selects an anchor resource block (RB) set and one or more non-anchor resource block (RB) set in a time unit. The user equipment performs a channel access procedure on the anchor RB set and the one or more non-anchor RB sets. Then, the user equipment transmits on at least one of the anchor RB set and the one or more non-anchor RB sets, a sidelink-synchronization signal block (S-SSB). In this way, the performance of the sidelink communication can be enhanced.

In some implementations of the method and apparatuses described herein, selecting the anchor RB set and the one or more non-anchor RB sets may comprise: selecting the anchor RB set and a first number of non-anchor RB sets, wherein the first number is equal to or greater than a minimum number, and the minimum number is obtained based on a pre-configuration and configuration.

In some implementations of the method and apparatuses described herein, transmitting the S-SSB may comprise: determining whether the anchor RB set is available based on the channel access procedure; and based on determining that the anchor RB set is available, transmitting the S-SSB on the anchor RB set.

In some implementations of the method and apparatuses described herein, transmitting the S-SSB may comprise: based on determining that the anchor RB set is unavailable, determining whether the one or more non-anchor RB sets are available based on the channel access procedure; and based on determining that a non-anchor RB set is available, transmitting the S-SSB on the non-anchor RB set.

In some implementations of the method and apparatuses described herein, transmitting the S-SSB may comprise: based on determining that a plurality of non-anchor RB sets are available, selecting a non-anchor RB set from the plurality of non-anchor RB sets; and transmitting, via the transceiver, the S-SSB on the selected non-anchor RB set.

In some implementations of the method and apparatuses described herein, selecting the non-anchor RB set from the plurality of non-anchor RB sets may comprise: selecting the non-anchor RB set randomly; or selecting the non-anchor RB set based on an index of the non-anchor RB set among the plurality of non-anchor RB sets.

In some implementations of the method and apparatuses described herein, the time unit is one of a plurality of time units that are included in a channel occupancy time (COT), and some implementations of the method and apparatuses described herein may further include obtain COT information that is associated with the COT.

In some implementations of the method and apparatuses described herein, the at least one of the anchor RB set and the one or more non-anchor RB sets comprises a first RB set, the user equipment is configured to use the first RB set in a second time unit in the COT and the second time unit is after the time unit. Some implementations of the method and apparatuses described herein may further include: determine whether the user equipment occupies the first RB set in the second time unit with a full RB set resource allocation or partial RB set resource allocation; based on determining that the user equipment occupies the first RB set with the full RB set resource allocation, transmit a cyclic prefix extension (CPE) before the second time unit; and based on determining that the user equipment occupies the first RB set with the partial RB set resource allocation, perform a listen before talk (LBT) procedure before the second time unit.

In some implementations of the method and apparatuses described herein, the at least one of the anchor RB set and the one or more non-anchor RB sets comprises a first RB set, the user equipment is configured to use the first RB set in a third time unit in the COT and the third time unit is before the time unit. Some implementations of the method and apparatuses described herein may further include: determine whether the user equipment occupies the first RB set in the third time unit with a full RB set resource allocation or a partial RB set resource allocation; based on determining that the user equipment occupies the first RB set with the full RB set resource allocation, transmit a CPE before the time unit; and based on determining that the user equipment occupies the first RB set with the partial RB set resource allocation, perform an LBT procedure before the time unit.

Some implementations of the method and apparatuses described herein may further include: transmitting the CPE to ensure that a gap in a first symbol before the second time unit or in a second symbol before the time unit is smaller than 16 us.

In some implementations of the method and apparatuses described herein, the COT is initiated by the user equipment.

In some implementations of the method and apparatuses described herein, the user equipment is configured to occupy a plurality of RB sets in a COT. Some implementations of the method and apparatuses described herein may further include: determining whether the anchor RB set is one of the plurality of RB sets; and based on determining that the anchor RB set is one of the plurality of RB sets, transmit: i) the S-SSB on the anchor RB set and padding data on at least one non-anchor RB set of the plurality of RB sets, or ii) the S-SSB on the at least one non-anchor RB set of the plurality of RB sets.

In some implementations of the method and apparatuses described herein, the user equipment is configured to occupy a plurality of RB sets in a COT. Some implementations of the method and apparatuses described herein may further include: determining whether the anchor RB set is one of the plurality of RB sets; in response that the user equipment is to transmit S-SSB, performing a channel access procedure on the anchor RB set based on determining that the anchor RB set is not one of the plurality of RB sets; transmitting, via the transceiver, the S-SSB on the anchor RB set; and transmitting, via the transceiver: i) padding data on at least one non-anchor RB set of the plurality of RB sets, or ii) the S-SSB on the at least one non-anchor RB set of the plurality of RB sets.

Some implementations of the method and apparatuses described herein may further include: transmitting, via the transceiver and using a first transmission power, the S-SSB on the anchor RB set, wherein the first transmission power is obtained based on pre-configuration or configuration.

Some implementations of the method and apparatuses described herein may further include: transmitting, via the transceiver and using a second transmission power, the S-SSB on a second number of non-anchor RB sets, wherein the second transmission power is determined based on the second number and a remaining transmission power other than the first transmission power.

In a second aspect of the solution, a user equipment selects, in a time unit, an anchor resource block (RB) set and one or more non-anchor RB sets. Then, the user equipment detects on at least one of the anchor RB set and the one or more non-anchor RB sets, a sidelink-synchronization signal block (S-SSB).

In a third aspect of the solution, a base station determines a minimum number of anchor resource block (RB) sets associated with a transmission of a sidelink-synchronization signal block (S-SSB). Then, the base station transmits, to a user equipment, information indicating at least one of: a minimum number of non-anchor resource block (RB) sets associated with a transmission of a sidelink-synchronization signal block (S-SSB), or a transmission power of the S-SSB on an anchor RB set.

### BRIEF DESCRIPTION OF THE DRAWINGS

FIG. 1A illustrates an example of a wireless communications system that supports sidelink transmission in unlicensed spectrum in accordance with aspects of the present disclosure.

FIG. 1B illustrates an exemplary S-SSB slot according to some embodiments of the present application.

FIG. 1C illustrates an exemplary distribution of S-SSB occasions in the time domain according to some embodiments of the present application.

FIG. 1D illustrates a timing configuration of an SSB transmission in accordance with some example embodiments of the present disclosure.

FIG. 1E illustrates another exemplary distribution of S-SSB occasions in the time domain according to some embodiments of the present application.

FIG. 1F illustrates an exemplary interlace RB-based structure for 15 kHz subcarrier spacing (SCS) in 20 MHz bandwidth according to some embodiments of the present application.

FIG. 2A through 2B illustrate examples signaling processes of a communication process that supports sidelink transmission in accordance with some example embodiments of the present disclosure.

FIG. 3 illustrates an example a COT overlapping with an SSB occasion in accordance with some example embodiments of the present disclosure.

FIGS. 4A through 4B illustrate examples of associations between a COT and an SSB occasion overlapping with the COT in accordance with some example embodiments of the present disclosure.

FIGS. 5A through 5B illustrate examples of SSB transmissions in the case of occupying multiple channels or RB sets during a COT.

FIGS. 6A through 6B illustrate other examples of associations between a COT and an SSB occasion overlapping with the COT in accordance with some example embodiments of the present disclosure.

FIGS. 7 through 9 illustrate examples of devices that support determination of RO groups in accordance with aspects of the present disclosure.

FIGS. 10 through 12 illustrate examples of processors that support determination of RO groups in accordance with aspects of the present disclosure.

FIGS. 13 through 15 illustrate flowcharts of methods that support sidelink transmission in accordance with aspects of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “communication network” refers to a network following any suitable communication standards, such as, 5G NR, long term evolution (LTE), LTE-advanced (LTE-A), wideband code division multiple access (WCDMA), high-speed packet access (HSPA), narrow band internet of things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), an NR NB (also referred to as a gNB), a remote radio unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VoIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an internet of things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

As mentioned above, the S-SSB is transmitted on the resources that are excluded from the above sidelink resource pool. In other words, the resources (which may be also referred to as “S-SSB occasion”) for transmitting the S-SSB cannot be used for transmitting the SL transmission within a configured bandwidth part (BWP), for example physical sidelink control channel (PSCCH) or physical sidelink shared channel (PSSCH). In this case, the coordination of the resources in the sidelink resource pool and the resources configured for the SSB transmission should be considered. For example, if COT initiated by a terminal device for SL transmission overlaps with resources configured for the S-SSB transmission in the time domain, how to handle the SL transmission and the S-SSB transmission should be solved. In addition, if the COT crosses the resources configured for the S-SSB transmission, reducing the COT loss (or interruption) caused by the S-SSB occasion is also a key aspect.

Accordingly, embodiments of the present disclosure provide a solution for sidelink transmission. In an aspect of the solution, user equipment selects an anchor RB set and one or more non-anchor RB sets in a time unit. For the selected anchor RB set and the one or more non-anchor RB sets, the user equipment performs a channel access procedure. Then, the user equipment transmits an S-SSB on at least one of the anchor RB set and the one or more non-anchor RB sets.

In this way, the S-SSB can be transmitted on anchor-RB set and/or one or more non-anchor RB sets. If the S-SSB can be transmitted on the anchor-RB set, the S-SSB reception UE can still only detect the an-RB set for the S-SSB without monitoring other resources. Alternatively, if the S-SSB cannot be transmitted on the anchor-RB set, the S-SSB may be also transmitted on other non-anchor RB sets in order to increase the SSB transmission opportunities or coverage. In addition, if the initiated COT is associated with multiple channels or RB sets, by transmitting the S-SSB on these RB sets, the non-anchor RB sets can be regarded by contention devices as occupied. Accordingly, the COT loss can be decreased.

Aspects of the present disclosure are described in the context of a wireless communications system.

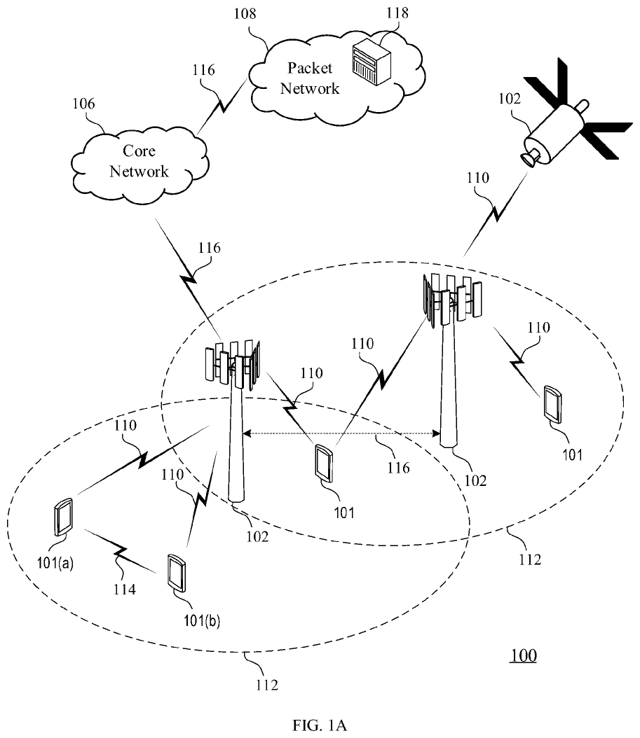

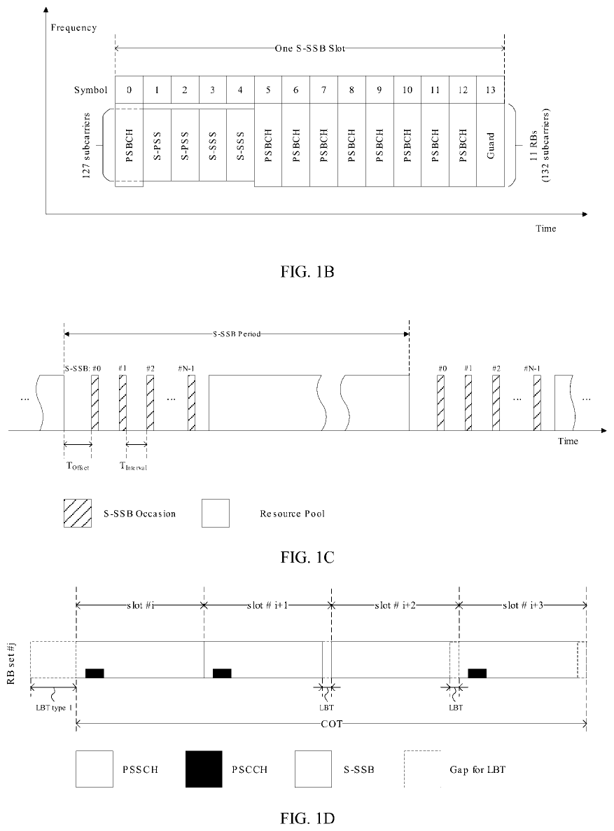

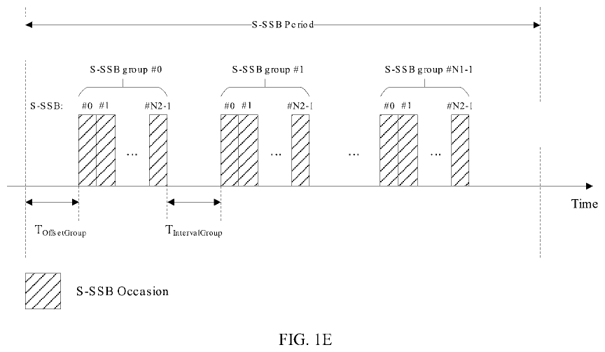

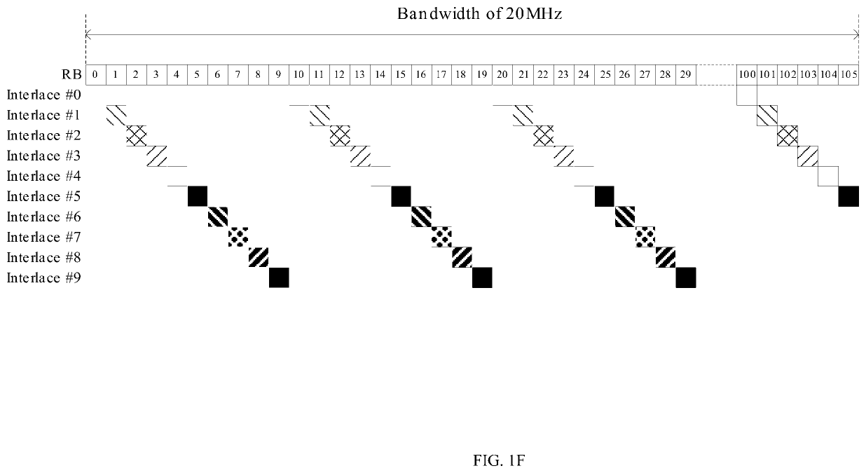

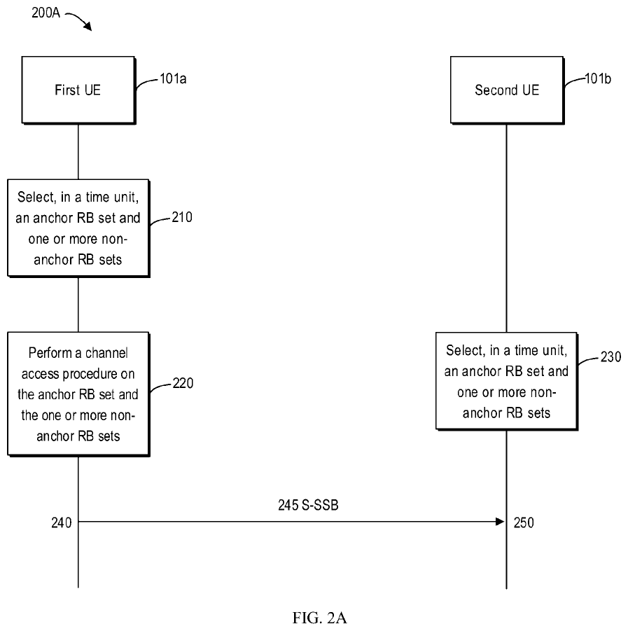

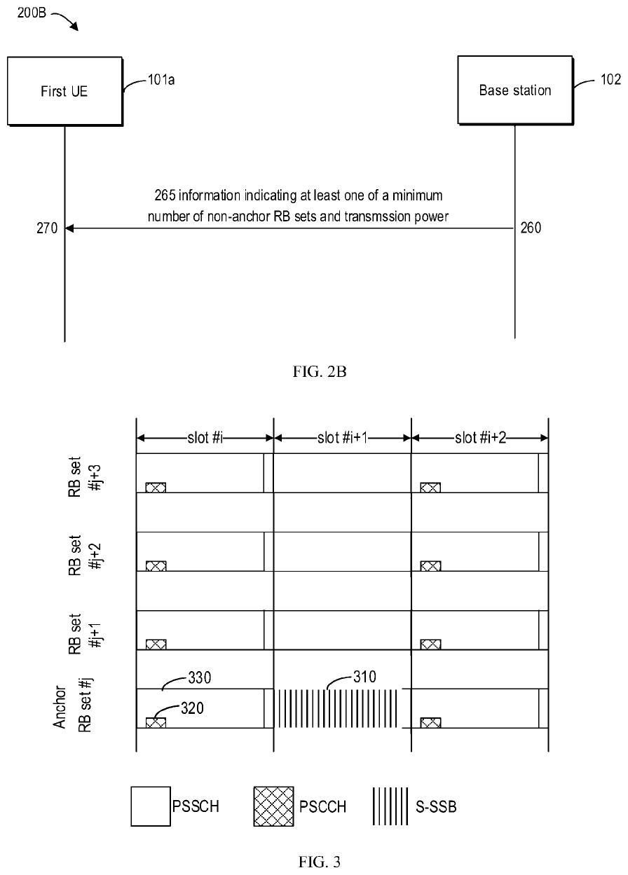

FIG. 1A illustrates an example of a wireless communications system 100 that supports sidelink transmission in accordance with aspects of the present disclosure. The wireless communications system 100 may include one or more network entities 102 (also referred to as network equipment (NE)), one or more UEs 101, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 101 may communicate via a communication link 110, which may be a wireless or wired connection. For example, a network entity 102 and a UE 101 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 101 within the geographic coverage area 112. For example, a network entity 102 and a UE 101 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 101 may be dispersed throughout a geographic region of the wireless communications system 100. A UE 101 may include or may be referred to as a mobile device, a wireless device, a remote device, a remote unit, a handheld device, or a subscriber device, or some other suitable terminology. In some implementations, the UE 101 may be referred to as a unit, a station, a terminal, or a client, among other examples. Additionally, or alternatively, the UE 101 may be referred to as an Internet-of-Things (IoT) device, an Internet-of-Everything (IoE) device, or machine-type communication (MTC) device, among other examples. In some implementations, a UE 101 may be stationary in the wireless communications system 100. In some other implementations, a UE 101 may be mobile in the wireless communications system 100.

The one or more UEs 101 may be devices in different forms or having different capabilities. Some examples of UEs 101 are illustrated in FIG. 1A. A UE 101 may be capable of communicating with various types of devices, such as the network entities 102, other UEs 101, or network equipment (e.g., the core network 106, the packet data network 108, a relay device, an integrated access and backhaul (IAB) node, or another network equipment), as shown in FIG. 1A. Additionally, or alternatively, a UE 101 may support communication with other network entities 102 or UEs 101, which may act as relays in the wireless communications system 100.

A UE 101 may also be able to support wireless communication directly with other UEs 101 over a communication link 114. For example, a UE 101 may support wireless communication directly with another UE 101 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 101 may support wireless communication directly with another UE 101 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 101 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUsor RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 101 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 101 may communicate with the application server 118. A UE 101 may establish a session (e.g., a protocol data unit (PDU) session, or the like) with the core network 106 via a network entity 102. The core network 106 may route traffic (e.g., control information, data, and the like) between the UE 101 and the application server 118 using the established session (e.g., the established PDU session). The PDU session may be an example of a logical connection between the UE 101 and the core network 106 (e.g., one or more network functions of the core network 106).

In the wireless communications system 100, the network entities 102 and the UEs 101 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 101 may support different resource structures. For example, the network entities 102 and the UEs 101 may support different frame structures. In some implementations, such as in 4G, the network entities 102 and the UEs 101 may support a single frame structure. In some other implementations, such as in 5G and among other suitable radio access technologies, the network entities 102 and the UEs 101 may support various frame structures (i.e., multiple frame structures). The network entities 102 and the UEs 101 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 101 may perform wireless communications over one or more of the operating frequency bands. In some implementations, FR1 may be used by the network entities 102 and the UEs 101, among other equipment or devices for cellular communications traffic (e.g., control information, data). In some implementations, FR2 may be used by the network entities 102 and the UEs 101, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing. Only for discussion purposes, the following embodiments are discussed with reference to any two or more UEs, for example, UEs 101(a) and UE (101b) as shown in FIG. 1 For discussion simplicity, the UE 101(a) may be used interchangeably with UE 101a, and the UE 101(b) may be used interchangeably with UE 101b,

In NR, accommodating multiple uncoordinated UEs in an unlicensed spectrum requires channel access procedures defined for NR. Following a successful channel access procedure performed by a communicating node, the channel can be used by the communicating node during a period until the end of the period. Such a period may be referred to as a COT. During a COT, one or more transmissions may be exchanged between the communicating nodes, wherein a transmission may be a downlink transmission or an uplink transmission.

Dynamic channel access procedures are usually used by a BS or a UE to access a channel in an unlicensed spectrum. Dynamic channel access procedures may be based on listen-before-talk (LBT), where a transmitter listens to potential transmission activity on a channel prior to transmitting and applies a random back-off time in some cases. Two main types of dynamic channel access procedures may be defined in NR. One is Type-1 dynamic channel access procedure, which is also referred to as LBT type 1 or LBT cat4. The other is Type-2 dynamic channel access procedure, which is also referred to as LBT type 2.

Type-1 dynamic channel access procedure may be used to initiate data transmission at the beginning of a COT. The initiator for the Type-1 dynamic channel access procedure may be either a BS or a UE. The Type-1 dynamic channel access procedure may be summarized as follows.

First, the initiator listens and waits until a channel (e.g., a frequency channel) is available during at least one period referred to as a defer duration. The defer duration may consist of 16 ρs and a number (e.g., “mₚ” in the following Table 1 or Table 2, which will be illustrated below) of 9 μs slots. As shown in Table 1 and Table 2, a value of “mₚ” depends on a value of channel access priority class (CAPC) (represented as “p”) Accordingly, the defer duration depends on the value of CAPC as shown in the following Table 1 or Table 2. A channel is declared to be available if the received energy during at least 4 μs of each 9 μs slot is below a threshold.

Once the channel has been declared available during the defer duration, the transmitter starts a random back-off procedure during which it will wait a random period of time.

The UE starts the random back-off procedure by initializing a back-off timer with a random number within a contention window (CW). The random number is drawn from a uniform distribution [0, CW] and represents that the channel must be available for a timer duration (e.g., denoted by the random number multiplying 9 μs) before transmission can take place. The value of “CW” may be selected from “allowed CWₚ sizes” (the minimum value is represented as CW_{min, p}, and the maximum value is represented as CW_{max, p}) in the following Table 1 or Table 2, which depends on a value of CAPC.

The back-off timer is decreased by one for each sensing slot duration (e.g., 9 μs) the channel is sensed to be idle; whenever the channel is sensed to be busy, the back-off timer is put on hold until the channel has been idle for a defer duration.

Once the back-off timer has expired (e.g., the back-off timer is decreased to be 0), the random back-off procedure is completed, and the transmitter has acquired the channel and can use it for transmission up to a maximum channel occupancy time (MCOT) (e.g., T_{m cot, p} in the following Table 1 or T_{ulm cot,p} in the following Table 2, which depends on a value of CAPC).

The following Table 1 and Table 2 illustrate exemplary CAPC for DL and CAPC for UL, respectively, and corresponding values of mₚ, CW_{min, p}, CW_{max, p}, T_{m cot, p}, T_{ulm cot, p}, and allowed CWₚ sizes. Table 1 is the same as Table 4.1.1-1 in TS 37.213 and Table 2 is the same as Table 4.2.1-1 in TS 37.213. When a BS intends to initiate a channel occupancy for DL transmission, it may determine a CAPC value before performing a Type-1 channel access procedure, and then determine the corresponding values (e.g., mₚ, CW_{min, p}, CW_{max, p}, T_{m cot, p}, and allowed CWₚ sizes) used in the Type-1 channel access procedure according to Table 1. When a UE intends to initiate a channel occupancy for UL transmission, it may determine a CAPC value before performing a Type-1 channel access procedure, and then determine the corresponding values (e.g., mₚ, CW_{min, p}, CW_{max, p}, T_{ulm cot, p}, and allowed CWₚ sizes) used in the Type-1 channel access procedure according to Table 2.

TABLE 1
Channel Access Priority Class for DL

| Channel | | | | | |
|---|---|---|---|---|---|
| Access | | | | | |
| Priority | | | | | |
| Class (p) | mₚ | CW_{min, p} | CW_{max, p} | T_{m cot, p} | allowed CWₚ sizes |
| 1 | 1 | 3 | 7 | 2 ms | {3, 7} |
| 2 | 1 | 7 | 15 | 3 ms | {7, 15} |
| 3 | 3 | 15 | 63 | 8 or 10 | {15, 31, 63} |
| | | | | ms | |
| 4 | 7 | 15 | 1023 | 8 or 10 | {15, 31, 63, 127, 255, |
| | | | | ms | 511, 1023} |

TABLE 2
Channel Access Priority Class for UL

| Channel | | | | | |
|---|---|---|---|---|---|
| Access | | | | | |
| Priority | | | | | |
| Class (p) | mₚ | CW_{min, p} | CW_{max, p} | T_{m cot, p} | allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, 255, |
| | | | | 10 ms | 511, 1023} |
| 4 | 7 | 15 | 1023 | 6 ms or | {15, 31, 63, 127, 255, |
| | | | | 10 ms | 511, 1023} |

NOTE1:
For p = 3, 4, T_{ulm cot, p} = 10 ms if the higher layer parameter ‘absenceOfAnyOtherTechnology-r14’ indicates TRUE, otherwise,
T_{ulm cot, p} = 6 ms.
NOTE 2:
When T_{ulm cot, p} = 6 ms it may be increased to 8 ms by inserting one or more gaps. The minimum duration of a gap shall be 100 μs. The maximum duration before including any such gap shall be 6 ms.

The size of the contention window may be adjusted based on hybrid automatic repeat request (HARQ) reports received from the transmitter during a reference interval, which covers the beginning of the COT. For each received HARQ report, the contention window is (approximately) doubled up to the limit CW_{max,p} if a negative HARQ report (e.g., non-acknowledgement (NACK)) is received. For a positive HARQ report (e.g., acknowledgement (ACK)), the contention window is reset to its minimum value, i.e., CW=CW_{min,p}.

Type-2 dynamic channel access procedure may be used for COT sharing and transmission of discovery bursts. Depending on a duration of a gap (also referred to as “COT sharing gap”) in the COT, Type-2 dynamic channel access procedure may be further classified into the following three procedures, wherein which procedure to be used may be determined depending on the duration of the gap between two transmission bursts.
Type 2A dynamic channel access procedure (also referred to as LBT cat2 or LBT type 2A): which is used when the gap is 25 μs or more for transmission of the discovery bursts.
Type 2B dynamic channel access procedure (also referred to as LBT type 2B): which is used when the gap is 16 μs.
Type 2C dynamic channel access procedure (also referred to as LBT type 2C): which is used when the gap is 16 μs or less after the preceding transmission burst.

For Type 2C dynamic channel access procedure, no idle sensing is required between the transmission bursts. In such scenario, the duration of a transmission burst is limited to at most 584 μs. Such a short transmission burst may carry small amount of user data, uplink control information (UCI) such as HARQ status reports and channel state information (CSI) reports.

Type 2A dynamic channel access procedure and Type 2B dynamic channel access procedure may be similar to Type-1 dynamic channel access procedure but without the random back-off. That is, in Type 2A dynamic channel access procedure and Type 2B dynamic channel access procedure, if a channel is detected to be idle in the gap, it is declared to be available; if it is detected to be busy, the COT sharing has failed and the transmission cannot occur using COT sharing in this COT. If the COT sharing gap is 16 μs, Type 2B dynamic channel access procedure may be used and the channel must be detected to be idle in the 16 μs gap prior to the next transmission burst. If the COT sharing gap is 25 μs or longer, Type 2A dynamic channel access procedure may be used and the channel must be detected to be idle during at least 25 μs immediately preceding the next transmission burst.

The above embodiments provide several dynamic channel access procedures in an unlicensed spectrum for NR. These dynamic channel access procedures may also apply for sidelink transmissions in an unlicensed spectrum.

Sidelink synchronization information is carried in an S-SSB that consists of physical sidelink broadcast channel (PSBCH), sidelink primary synchronization signal (S-PSS) and sidelink secondary synchronization signal (S-SSS). FIG. 1B illustrates an exemplary S-SSB slot according to some embodiments of the present disclosure. In the embodiments of FIG. 1B, a normal cyclic prefix (CP) is used.

Referring to FIG. 1B, an S-SSB occupies one slot in the time domain and occupies 11 resource blocks (RBs) in the frequency domain. Each RB spans 12 subcarriers, thus the S-SSB bandwidth is 132 (11×12) subcarriers. In the example of FIG. 1B, the S-SSB slot may include 14 OFDM symbols in total, e.g., symbol #0 to symbol #13. The S-PSS is transmitted repeatedly on the second and third symbols in the S-SSB slot, e.g., symbol #1 and symbol #2. The S-SSS is transmitted repeatedly on the fourth and fifth symbols in the S-SSB slot, e.g., symbol #3 and symbol #4. The S-PSS and the S-SSS occupy 127 subcarriers in the frequency domain, which are from the third subcarrier relative to the start of the S-SSB bandwidth up to the 129th subcarrier.

The S-PSS and the S-SSS are jointly referred to as the sidelink synchronization signal (SLSS). The SLSS is used for time and frequency synchronization. By detecting the SLSS sent by a synchronization reference UE (also referred to as a SyncRef UE), a UE is able to synchronize to the SyncRef UE and estimate the beginning of the frame and carrier frequency offsets.

The S-PSS may be generated from the maximum length sequences (m-sequences) that use the same design (i.e., generator polynomials, initial values and cyclic shifts, etc.) which is used for generating the m-sequences in the primary synchronization signal (PSS) in the 3GPP documents. In NR Uu, there are three candidate sequences for PSS. However, only two candidate sequences are used for S-PSS.

The S-SSS may be generated from the Gold sequences that use the same design (i.e., generator polynomials, initial values and cyclic shifts, etc.) which is utilized for generating the Gold sequences for the secondary synchronization signal (SSS) in the 3GPP documents. This results in 336 candidate sequences for S-SSS like for the SSS in NR Uu.

For the transmission of SLSS within an S-SSB, a SyncRef UE may select an S-PSS and an S-SSS out of the candidate sequences based on an SLSS identifier (ID). The SLSS ID represents an identifier of the SyncRef UE and conveys a priority of the SyncRef UE as in LTE vehicle-to-everything (V2X). Each SLSS ID corresponds to a unique combination of an S-PSS and an S-SSS out of the 2 S-PSS candidate sequences and the 336 S-SSS candidate sequences.

The main purpose of the PSBCH is to provide system-wide information and synchronization information that is required by a UE for establishing a sidelink connection. In the example of FIG. 1B, the PSBCH is transmitted on the first symbol (e.g., symbol #0) and the eight symbols (e.g., symbol #5 to symbol #12) after the S-SSS in the S-SSB slot. In the case that an extended CP is used, the PSBCH is transmitted on the first symbol and the six symbols after the S-SSS in the S-SSB slot. The PSBCH occupies 132 subcarriers in the frequency domain. The PSBCH in the first symbol of the S-SSB slot is used for automatic gain control (AGC). The last symbol, e.g., symbol #13, in the S-SSB slot is used as a guard symbol.

The structure of S-SSB slot in FIG. 1B is only for illustrative purpose. It is contemplated that along with developments of network architectures and new service scenarios, the S-SSB may have other structures (for example, the S-SSB may include 4 OFDM symbols or 6 OFDM symbols in the time domain), which should not affect the principle of the present application.

In some embodiments, S-SSBs may be organized with a fixed periodicity. Such fixed periodicity may be referred to as an S-SSB period. There are one or more S-SSB occasions within an S-SSB period. A distribution of S-SSB occasions in the time domain may be determined based on at least one of the following parameters:
S-SSB period, which indicates a length of an S-SSB period;
T_{offset}, which indicates a time offset between the starting of the S-SSB period and the first S-SSB occasion within the S-SSB period;
T_{Interval}, which indicates a time interval between two adjacent S-SSB occasions within the S-SSB period: for example, Tᵢₙₜₑᵣᵥₐₗ may be defined in unit of slots and within a range of INTEGER (0 . . . 639) (i.e., a value of Tᵢₙₜₑᵣᵢᵥₐₗ may be an integer between 0 and 639); or
N, which indicates the number of S-SSB occasions within the S-SSB period.

In some embodiments, a UE may obtain a configuration including at least one of: S-SSB period, T_{offset}, Tᵢₙₜₑᵣᵥₐₗ, or N, and thus a distribution of S-SSB occasions in the time domain may be determined by the UE.

FIG. 1C illustrates an exemplary distribution of S-SSB occasions in the time domain according to some embodiments of the present disclosure.

FIG. 1C illustrates an S-SSB period as an example. Resource pool is also illustrated in the figure. A resource pool may define the overall time and frequency domain resources that can be used for SL transmission within a carrier. The SL transmission in the embodiments of the present application may refer to at least one of physical sidelink control channel (PSCCH) transmission or physical sidelink shared channel (PSSCH) transmission. In the time domain, the resource pool consists of a set of slots repeated over a resource pool period. Although the set of slots within the resource pool are logically organized in a consecutive way, actually the slots within the resource pool may be discretely distributed in the time domain.

As shown in FIG. 1C, in the S-SSB period, N S-SSB occasions are included, which are labeled by S-SSB occasion #0, S-SSB occasion #1, S-SSB occasion #2, . . . , S-SSB occasion #N−1, respectively.

A length of the S-SSB period is marked as “S-SSB Period” in FIG. 1C. There is a time offset between the starting of the S-SSB period and the first S-SSB occasion within the S-SSB period, which is marked as “T_{Offset}” in FIG. 1C. There is a time interval between two adjacent S-SSB occasions (e.g., between the ending point of the former S-SSB occasion and the starting point of the latter S-SSB occasion), which is marked as “T_{Interval}” in FIG. 1C.

In 3GPP Release 16 (Rel-16) or Release 17 (Rel-17), the S-SSB period may include 160 ms, as specified in NR V2X. However, along with developments of network architectures and new service scenarios, the S-SSB period may have other values, which should not affect the principle of the disclosure.

In 3GPP Rel-16 or Rel-17, the S-SSB occasion(s) are excluded from a resource pool in the time domain. For example, the distribution of S-SSB occasion(s) in 3GPP Rel-16 or Rel-17 (also referred to as legacy S-SSB occasion(s)) may be denoted by at least one of the following parameters: S-SSB period, T_{Offset}, T_{Interval}, or N as stated above.

The S-SSB transmissions in unlicensed spectrum may be subject to a channel access procedure as stated above. That is, transmitting S-SSB on a target S-SSB occasion requires a successful channel access procedure prior to the target S-SSB occasion. The channel access opportunities for transmitting S-SSB in unlicensed spectrum may be reduced due to resource collision or LBT failure. To compensate for the case that some S-SSB occasions are unavailable for transmitting S-SSB, in 3GPP Release 18 (Rel-18), additional S-SSB occasion(s) are introduced for transmitting S-SSB in unlicensed spectrum to achieve the desired amount of channel access opportunities. The additional S-SSB occasion(s) may also be excluded from the resource pool in the time domain.

As a feature in unlicensed spectra, a COT-based transmission may be applied in sidelink. For example, for SL transmissions, a COT may be initiated by one UE (referred to as COT initiating UE) and shared to one or more other UEs (referred to as COT responding UEs). The COT may be initiated by Type-1 dynamic channel access procedure. During the COT, one or more transmission bursts can be exchanged between the COT initiating UE and the one or more COT responding UEs, where a transmission burst corresponds to one direction of an SL transmission.

For NR Uu in unlicensed spectra, the length of MCOT may be up to 10 ms. Such MCOT may also be applied for the sidelink. Accordingly, there may be a case where one or more S-SSB occasions overlap with a COT. An S-SSB occasion overlapping with a COT may refer to that the COT includes the S-SSB occasion or the S-SSB occasion is included in or within the COT.

FIG. 1D illustrates exemplary locations of S-SSB occasion(s) and a COT for sidelink transmission in an RB set according to some embodiments of the present application.

Referring to FIG. 1D, in an RB set (e.g., RB set #j), a COT for SL transmission may start from slot #i and has a length of 4 slots (e.g., including slot #i, slot #i+1, slot #i+2, and slot #i+3). Each slot may include 14 OFDM symbols (e.g., from symbol 0 to symbol 13). Within the COT, slot #i+2 is an S-SSB occasion, which may be either a legacy S-SSB occasion (defined in Rel-16 or Rel-17) or an additional S-SSB occasion (introduced in Rel-18). Each of the other slots in the COT may be used for an SL transmission, which includes at least one of a PSCCH transmission and a PSSCH transmission.

The COT may be initiated by an LBT type 1 procedure before slot #i. Within the COT, a UE may perform SL transmissions in one or more slots. In the case that the UE performs SL transmissions in two or more consecutive slots (e.g., slot #i and slot #i+1, the UE may not need to perform LBT or may perform an LBT type 2 with a short duration (e.g., less than 16 μs) between the slots. That is, there may be no gap or may be a short gap between SL transmissions in two consecutive slots. For different kinds of transmissions in two consecutive slots, there may be a gap for LBT between the transmissions. For example, before the S-SSB transmission in slot #i+2 or the SL transmission in slot #i+3, there may exist a gap to perform LBT.

Although FIG. 1D illustrates that one S-SSB occasion overlaps with a COT, there may be cases where more than one S-SSB occasion overlaps with a COT.

FIG. 1C illustrates an example of an exemplary distribution of S-SSB occasions in the time domain according to some embodiments of the present application. Without any limitation, another exemplary distribution of S-SSB occasions is further discussed with reference to FIG. 1E.

FIG. 1E illustrates an exemplary distribution of S-SSB occasions in the time domain, which are organized in the aforementioned grouping manner, according to some embodiments of the present disclosure.

FIG. 1E illustrates an S-SSB period as an example. A length of the S-SSB period is marked as “S-SSB Period” in FIG. 1E. The S-SSB period includes N1 S-SSB groups, which are S-SSB group #0, S-SSB group #1, . . . , and S-SSB group #N1−1. Each S-SSB group includes N2 consecutive S-SSB occasions, which are S-SSB occasion #0, S-SSB occasion #1, . . . , and S-SSB occasion #N2−1.

There is a time offset between the starting of the S-SSB period and a starting of the first S-SSB group within the S-SSB period, which is marked as “T_{OffsetGroup}” in FIG. 1E. There is a time interval between two adjacent S-SSB groups (e.g., between the ending point of the former S-SSB group and the starting point of the latter S-SSB group), which is marked as “T_{IntervalGroup}” in FIG. 1E. Accordingly, the distribution of S-SSB occasions in the example of FIG. 1E may be defined by a configuration (e.g., configuration #2 as described above) which includes at least one of: the parameter “S-SSB Period,” the parameter “T_{OffsetGroup},” the parameter “T_{IntervalGroup},” the parameter “N1,” or the parameter “N2.”

In this disclosure, the term “interlace” may refer to a plurality of resource blocks in a Resource Block (RB) set, and the plurality of resource blocks are distributed in the RB set, for example, in a comb form. Only for illustration purposes, the interlace is further discussed with reference to FIG. 1F.

FIG. 1F illustrates an exemplary interlace RB-based structure for 15 kHz subcarrier spacing (SCS) in 20 MHz bandwidth according to some embodiments of the present application.

FIG. 1F illustrates an exemplary interlace RB-based structure (also referred to as interlace pattern) for 15 kHz SCS in 20 MHz bandwidth according to some embodiments of the present application. It should be understood that the interlace RB-based structure in FIG. 1F is only for illustrative purposes and should not be construed as limiting the embodiments of the present disclosure.

As shown in FIG. 1F, the channel (e.g., RB set) with 20 MHz bandwidth may include 106 RBs (e.g., denoted as RBs 0-105), and the RBs of the channel are divided into 10 interlaces (denoted as interlaces #0-#9). Within interlaces #0 to #5, each interlace contains 11 RBs. Within interlaces #6 to #9, each interlace contains 10 RBs.

Each interlace of the 10 interlaces may include evenly-spaced RBs in the frequency domain. As shown in FIG. 1F, interlace #0 may include RB 0, RB 10, RB 20, RB 30, and so on; interlace #1 may include RB 1, RB 11, RB 21, RB 31, and so on; . . . ; and interlace #9 may include RB 9, RB 19, RB 29, and so on.

According to some embodiments of the present application, multiple RB sets may be available for S-SSB transmission. For S-SSB, transmission across multiple RB sets may increase channel access opportunities in unlicensed spectra. In addition, multiple RB sets are beneficial for providing sufficient RBs for S-SSB transmission, especially for interlace RB-based S-SSB transmission. Therefore, new designs for related slot structures of S-SSB and UE behavior for S-SSB transmission(s) on multiple RB sets (or channels) are needed.

In addition, only for illustration purposes, the following Table 3 illustrates an exemplary of max transmission bandwidth configuration N_{RB} for FR 1(450-7125 MHz), where the N_{RB} represents the number of resource blocks.

TABLE 2

| | | 10 | 15 | 20 | 25 | 30 | 40 | 50 | 60 | 80 | 100 |
|---|---|---|---|---|---|---|---|---|---|---|---|
| SCS | | MHz | MHz | MHz | MHz | MHz | MHz | MHz | MHz | MHz | MHz |
| (KHz) | | N_{RB} | N_{RB} | N_{RB} | N_{RB} | N_{RB} | N_{RB} | N_{RB} | N_{RB} | N_{RB} | N_{RB} |
| 15 | 25 | 52 | 79 | 106 | 133 | [160] | 216 | 270 | N/A | N/A | N/A |
| 30 | 11 | 24 | 38 | 51 | 65 | [78] | 106 | 133 | 162 | 217 | 273 |
| 60 | N/A | 11 | 18 | 24 | 31 | [38]0 | 51 | 65 | 79 | 107 | 135 |

Given the above, embodiments of the present application provide solutions for for sidelink transmission in unlicensed spectra. For example, embodiments of the present application provide several solutions regarding S-SSB slot structure and UE behavior for supporting S-SSB transmission(s) on multiple RB sets (or channels), which may increase channel access opportunities and provide sufficient RBs for S-SSB transmission in unlicensed spectra. More details will be described in the following text in combination with the appended drawings.

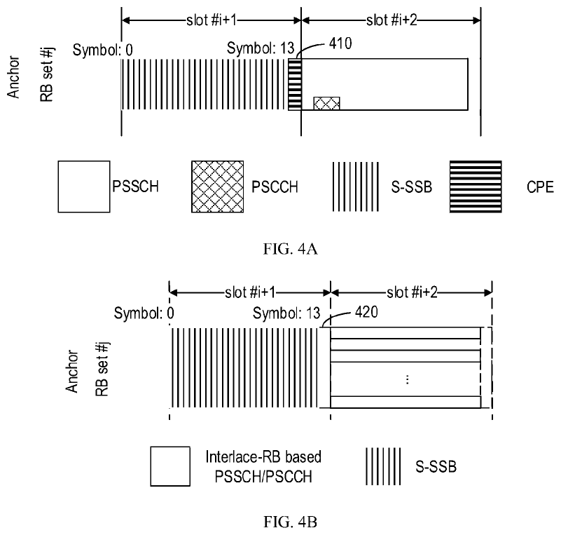

Reference is now made to FIG. 2A, which illustrates an example signaling process 200A of a communication process that supports sidelink transmission in accordance with some example embodiments of the present disclosure. For the purpose of discussion, the process 200A will be described with reference to FIG. 1A. The process 200A may involve the UE 101a (which may be also referred to as a first UE 101a in this disclosure) and UE 101b (which may be also referred to as a second UE 101b in this disclosure). It is to be understood that the steps and the order of the steps in FIG. 2 are merely for illustration, and not for limitation. It is to be understood that process 200A may further include additional blocks not shown and/or omit some shown blocks, and the scope of the present disclosure is not limited in this regard.

As shown in FIG. 2A, in the case that the first UE 101a is to transmit or broadcast an S-SSB, the first UE 101a selects 210 an anchor RB set and one or more non-anchor RB sets in a time unit. In some embodiments, this time unit may be the configured S-SSB occasion as mentioned above. Without any limitation, this time unit for S-SSB transmission may be also referred to S-SSB occasion in this disclosure. Alternatively, without any limitation, the time unit may be any duration in the time domain, for example, symbol, slot, subframe, frame, etc. Only for discussion simplicity, the time unit is a slot in the following embodiments. Furthermore, the time unit may be one of a plurality of time units in an initiated COT. Alternatively, the time unit may be also outside of the COT.

The RB set (anchor RB set or non-anchor RB set) refers to a group of resource blocks in the frequency domain. Specifically, for unlicensed spectra, the carriers wider than 20 MHz can be divided into multiple 20 MHz channels upon which the channel access procedure is defined. Each of the 20 MHz is also referred to as one resource block (RB) set. In addition, operating with wider carriers may require guard bands between RB sets. The size of the guard bands has been chosen such that no filtering is needed to ensure that transmission on one RB set does not cause significant interference to a neighboring RB set not available for transmission. Accordingly, in this disclosure, the terms “channel” and “RB set” can be used interchangeably. Furthermore, the anchor RB set may refer to the RB set where S-SSB indicated by sl-AbsoluteFrequencySSB-r16 locates. Accordingly, the non-anchor RB set may refer to the RB sets other than the indicated anchor RB set.

In addition, there may be several situations that the first UE 101a needs to transmit the S-SSB. Specifically, legacy rules of triggering S-SSB transmission as specified in R16/R17 can be applied for the UE discussed in this disclosure as a baseline, which are summarized as follows:

```
(1) A UE is configured by the network to become a synchronization reference
(SyncRef) UE when the UE is in network coverage, which is optional.
  A network configured SyncRef UE sends S-SSBs irrespective of whether it has
  any data to transmit in the sidelink
(2) A UE decides on its own whether to become a SyncRef UE if the UE has data to
transmit in the sidelink and if the UE in network coverage has not received a
configuration to become a SyncRef UE from network
  The determination is made by comparing RSRP measured on RS (e.g., PBCH
  DMRS) sent by the serving gNB/eNB and a (pre-)configured RSRP threshold. If
  the measured RSRP is below the threshold, the UE can become a SyncRef UE.
  Otherwise, the UE does not send S-SSBs.
(3) A UE decides on its own whether to become a SyncRef UE if the UE has data to
transmit in the sidelink and if the UE is synchronized to a SyncRef UE (i.e., out of
network coverage).
  The determination is made by comparing RSRP measure on RS (e.g., PSBCH
  DMRS) send by its selected SyncRef UE and a (pre-)configured RSRP
  threshold. If the measured RSRP is below the threshold, the UE can become a
  SyncRef UE. Otherwise, the UE does not send S-SSBs.
(4) A UE decides to become a SyncRef UE if the UE has data to transmit in the sidelink
and if the UE uses its internal clock as synchronization reference.
```

In some embodiments, for simplifying the reception of S-SSB, the UE 110a should transmit S-SSB on at least the anchor RB set and this S-SSB transmission manner may be also referred to as “Option 1” in this disclosure. Alternatively, the UE 110a may also transmit S-SSB on non-anchor RB sets and/or anchor RB set for increasing the S-SSB transmission opportunities. This alternative S-SSB transmission manner may be also referred to as “Option 2” in this disclosure.

In this disclosure, the UEs may be divided into two classes based on whether UEs are aware of the above time unit overlaps with an initiated COT. If the time unit overlaps with an initiated COT while UE is not aware of the information that the above time unit overlaps with an initiated COT, this UE may be referred to as Class-1 UE. Otherwise, the UE is referred to as Class-2 UE. For example, if UE initiated a COT or UE is shared with a COT and this responding UE gets the information associated with the COT, then the UE may determine whether the COT overlaps with the time unit based on the S-SSB configuration (for example, configured S-SSB occasions). Without any limitation, the information associated with the COT may include at least one of: a starting slot of the COT, a duration of the COT, or a remaining duration of the COT. Only for discussion simplicity, in the following embodiments, the “Class-1 UE” and “Class-2 UE” may refer to the above two cases.

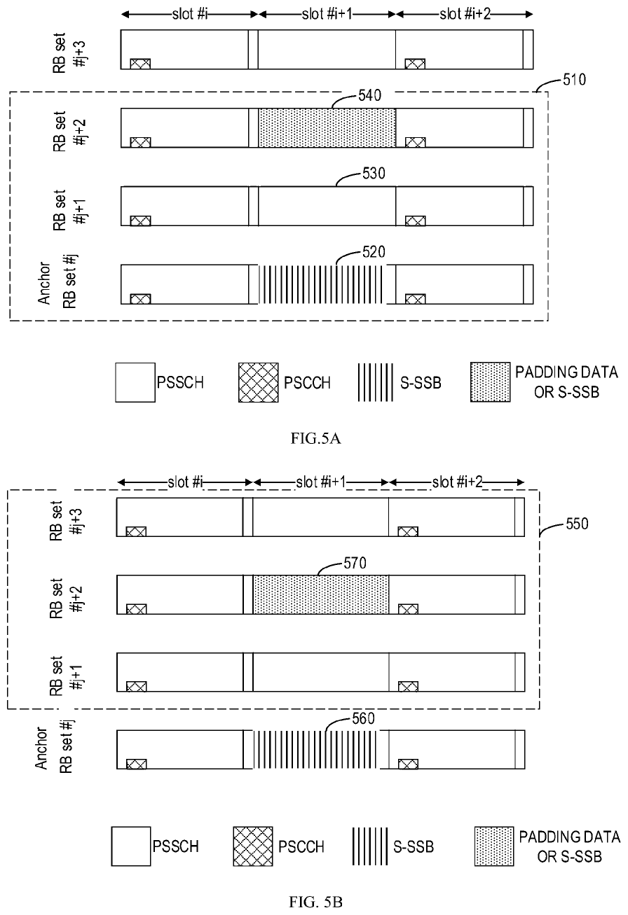

In addition, only for discussion purposes, the cases that the COT overlaps with the time unit for S-SSB are further discussed with reference to FIG. 3. FIG. 3 illustrates an example a COT overlapping with an SSB occasion in accordance with some example embodiments of the present disclosure.

As mentioned above, S-SSB occasion(s) occasions are excluded from resource pool as agreed in 3GPP. If the location and number of S-SSB are configured per BWP, there could be the case where S-SSB and sidelink data (PSSCH/PSCCH) transmissions from different RB sets are not allowed to locate within the same slot. As shown in FIG. 3, four RB sets within a BWP are labelled as RB sets from #j to #j+3 and three slots are labelled as slots from #i to #i+2. The slots of #i and #i+2 are for PSSCH/PSCCH transmission (for example, PSCCH 320 and PSSCH 330), while slot #i+1 is for S-SSB. In the example of FIG. 3, RB set #j is the anchor RB set, on which default S-SSB occasions 310 locate. That is, the default S-SSB resource 310 locates at RB set #j and slot #i+1. Accordingly, the time unit 310 overlaps with the COT occupying slots #i to #i+2, and the SL transmission cannot be performed on time unit 310. In this case, there may be a risk of losing the COT since there is no transmission on RB sets #j+1 to j+3, and other contention devices may determine that these RB sets are available. Furthermore, The UE that is not aware of this situation is Class-1 UE. Otherwise, the UE is Class-2 UE.

Referring back to FIG. 2A, regarding the selection of non-anchor RB sets, the first UE 101a may select a first number of non-anchor RB sets, and the first number is equal to or greater than a minimum number. In an example, the minimum number may be configured, pre-configured, pre-defined, or defined per frequency range (FR), per bandwidth part (BWP), per carrier, per resource block (RB) set, or per resource pool (RP) configuration. In an example, the minimum number may be received 205 via at least one of: a master information block (MIB) message, a system information block (SIB) message, a radio resource control (RRC) signaling, a medium access control (MAC) control element (CE), or downlink control information (DCI). Accordingly, the base station 130 may transmit 201 to the first UE 101a information 203 indicating the minimum number through the above signaling or configurations. For discussion clarity, the information or indication of the minimum number is further discussed with reference to FIG. 2B and is not further discussed here.

In some embodiments, the first UE 101a may select the one or more non-anchor RB sets in addition to the anchor RB set. Alternatively, the first UE 101a may also select the one or more non-anchor RB sets by any other manners, which is not limited in this disclosure. For example, how to select non-anchor RB set(s) can be left up to UE implementation.

Then, the first UE 101a performs 220 a channel access procedure on the selected anchor RB set and one or more non-anchor RB sets. In some embodiments, for example, UE 101a belongs to Class-1 UE, the first UE 101a may perform multiple channel access procedures towards the (target) S-SSB occasion(s) in the selected anchor RB set and non-anchor RB set(s). In addition, the multiple channel access procedures can be one of Type A or Type B.

After the channel access procedure, the first UE 101a transmits 240 the S-SSB on at least one of the selected anchor RB set and one or more non-anchor RB sets. In some embodiments, according to the results of the multiple channel access procedures, the first UE 101a performs S-SSB transmission on at least one of the available RB set(s) that the corresponding channel access procedure is successful. In some embodiments, for simplifying the reception of S-SSB, the first UE 101a prioritizes the S-SSB transmission on the anchor RB set (for example, the anchor RB set 310 as shown in FIG. 3). For example, the first UE 101a may firstly determine whether the anchor RB set is available based on the channel access procedure. If the anchor RB set is available, the first UE 101a may transmit the S-SSB on the anchor RB set. In addition, if the anchor RB set is unavailable, the first UE 101a may further determine whether the one or more non-anchor RB sets are available based on the channel access procedure. Then, if a non-anchor RB set is available, the first UE 101a may transmit the S-SSB on the non-anchor RB set. In addition, if more than one non-anchor RB sets are determined as available, the first UE 101a may select a non-anchor RB set from the plurality of non-anchor RB sets and transmit the S-SSB on the selected non-anchor RB set. The selecting the non-anchor RB set may be performed by selecting the non-anchor RB set randomly or selecting the non-anchor RB set based on an index of the non-anchor RB set among the plurality of non-anchor RB sets.

In a specific example, the first UE 101a may prioritize SSB transmission on the anchor RB-set as follows: If the anchor RB set is available, then the first UE 101a performs S-SSB transmission in the S-SSB occasion in the anchor RB set; else, if at least one non-anchor RB set is available, then the first UE 101a performs S-SSB transmission in the S-SSB occasion in one non-anchor RB set. In addition, if more than one non-anchor RB set are available, the first UE 101a can randomly select one RB set within the available RB sets; or the first UE 101a can select the RB set with minimal (or maximal) index within the available RB sets. Otherwise, the first UE 101a drop S-SSB transmission in the S-SSB occasion.

Although the above embodiments are discussed in the case that the first UE 101a belongs to Class-1, the first UE 101a may be also Class-2 UE. In addition or alternatively, even if the first UE 101a transmits the S-SSB on the anchor RB set, the first UE 101a may further transmit S-SSB on a non-anchor RB set for assisting to maintain the COT.

The above embodiments provide a solution that the first UE 101a may transmit the S-SSB on at least one of anchor RB set and one or more non-anchor RB sets. In this way, the monitoring of S-SSB may be simplified or the S-SSB opportunities can be increased. In addition, if the first UE 101a belongs to Class-2 UE, i.e., the first UE 101a is aware of the time unit overlaps with an initiated COT (as shown by FIG. 3), the first UE 101a may perform some further operations to optimize the S-SSB transmission or ensure the COT.

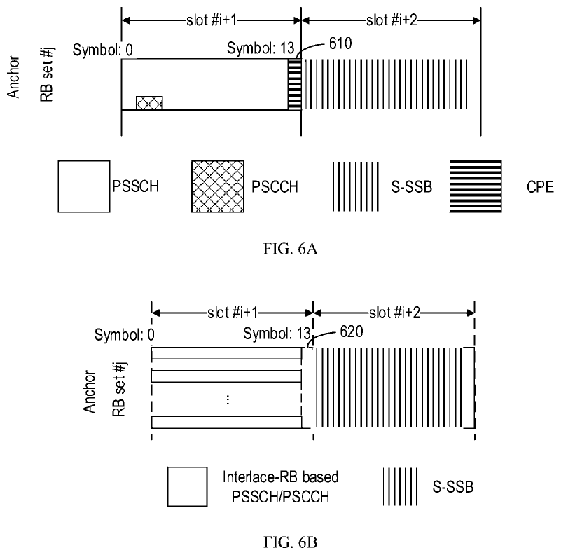

In some embodiments, the first UE 101a, which will utilize the slot immediately after an S-SSB occasion to transmit sidelink data, will attempt to perform transmission in the S-SSB slot. The first UE 101a can be either COT initiating UE or COT responding UE of the COT. In an example, assuming that the first UE 101a transmits S-SSB on a selected single RB set. In this disclosure, this single RB set may be also referred to as the first RB set. In addition, the first UE 101a is configured to use this first RB set in a second time unit in the COT and the second time unit is after the above time unit. In this case, based on whether the first UE 101a is enabled to occupy the first RB set in the second time unit with full RB set resource allocation or partial RB set resource allocation, the first UE 101a may perform different operations to attempt the occupancy of the second time unit. For discussion clarity, these embodiments are further discussed with reference to FIGS. 4A and 4B.

FIGS. 4A through 4B illustrate examples of associations between a COT and an SSB occasion overlapping with the COT in accordance with some example embodiments of the present disclosure.

As shown in FIG. 4A, the slot #i+1 may be the above time unit for S-SSB transmission, for example, S-SSB occasion. The slot #i+2 may be the second time unit. In some embodiments, the first UE 101a may determine whether the first UE 101a occupies the first RB set in the slot #i+2 with a full RB set resource allocation or partial RB set resource allocation. If determining that first UE 101a occupies the first RB set with the full RB set resource allocation, the first UE 101a may transmit a cyclic prefix extension (CPE) before the slot #i+2. For example, as shown in FIG. 4A, after transmitting the S-SSB in slot #i+1, the first UE 101a may transmit the CPE to ensure that a gap in a first symbol 410 (for example, the symbol #13 in the S-SSB occasion) before the second time unit equals to or is smaller than 16 us. In this way, the first UE 101a may occupy the slot #i+2, i.e., the second time unit, in advance, since there is not enough time for other device to perform a Type 2 channel access procedure.

In a specific example, in the case of full RB set resource allocation (for sidelink data transmission), it is no need to set a gap for LBT between the target S-SSB slot #i+1 and the succeeding SL data slot. The first UE 101a may, within the symbol #13 in the slot #i+1, transmit CP extension (CPE) to ensure the gap not larger than 16 us. The motivation is to occupy the channel. Then, the first UE 101a can perform SL data transmission in the slot (#i+2) immediately after the S-SSB slot.

Alternatively, if determining that the first UE 101a occupies the first RB set with the partial RB set resource allocation, the first UE 101a may perform a listen before talk (LBT) procedure before the second time unit. For discussion clarity, this embodiment is further discussed with reference to FIG. 4B. As shown in FIG. 4B, similarly the slot #i+1 may be the above time unit for S-SSB transmission, for example, S-SSB occasion, while the first UE 101a is configured to occupy the second time unit with the partial RB set resource allocation. In a specific example, if the first RB set in slot #i+2 is partially occupied (for example, by means of one or more interlace(s) in case of interlaced-RB based waveform) by the first UE 101a, a gap for LBT is needed between the target S-SSB slot #i+1 and the succeeding SL data slot. Thus, the last one (symbol #13) or more symbols in the S-SSB slot is set for LBT purpose. The number of symbols for LBT is related to SCS.

The above embodiments are discussed based on a single RB set, while in some embodiments, the COT may be initiated by performing the multiple channel access procedures for more than one RB sets. In this case, if the S-SSB occasion (i.e., the above time unit for transmitting S-SSB) overlaps with the COT, the first UE 101a may determine whether the RB set (for example, the anchor RB set) for the S-SSB is within the plurality of RB sets of these channels.

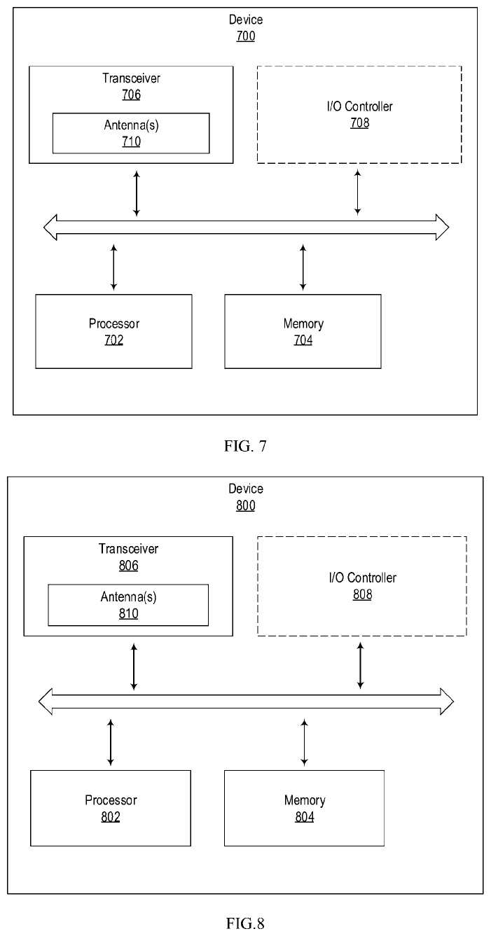

In some embodiments, if the anchor RB set is one of the plurality of RB sets, the first UE 101a may transmit the S-SSB on the anchor RB set. In addition, the first UE 101a may also transmit padding data on one or more other RB sets of the plurality of RB sets. In this way, the S-SSB is at least transmitted on the anchor RB set, so that the reception of S-SSB is simplified. Moreover, there is also padding data in other RB sets. As such, the probability of COT lost can be reduced. For discussion clarity, this embodiment is further discussed with reference to FIG. 5A.

FIG. 5A illustrates an example of SSB transmissions in the case of occupying multiple channels or RB sets during a COT.

As shown in FIG. 5A, the first UE 101a occupies the RB sets #j to j+2 for a COT duration: slots #i to i+2. That is, the anchor RB set #j is within these RB sets. In this case, the first UE 101a may transmit S-SSB on the anchor RB set 520 (i.e., the above “option 1”). In addition, the first UE 101a may also transmit padding data on RB set #j+2 (540). Without any limitation, the padding data may be S-SSB (i.e., the above “option 2”). In a specific example, in the anchor RB set, S-SSB needs to be transmitted by the first UE 101a in the S-SSB occasion(s) within the COT. In addition, in the non-anchor RB set(s) within the COT, either dummy data (e.g., dummy data in one interlace in case of interlaced-RB based waveform) or S-SSB can be transmitted in S-SSB occasion in the non-anchor RB set(s) by the first UE 101a to avoid COT lose. Alternatively, the S-SSB is transmitted by the first UE 101a in the non-anchor RB set(s) within S-SSB occasion to avoid COT lose.

Alternatively, the anchor RB set may be outside the plurality of RB sets for the initiated COT. In some embodiments, if the anchor RB set is not one of the plurality of RB sets, the first UE 101a may perform a channel access procedure on the anchor RB set in response that the user equipment is to transmit S-SSB. Then, the first UE 101a may transmit the S-SSB on the anchor RB set. In addition, the first UE 101a may further transmit i) padding data on at least one non-anchor RB set of the plurality of RB sets, or ii) the S-SSB on the at least one non-anchor RB set of the plurality of RB sets.

FIG. SB illustrates another example of SSB transmissions in the case of occupying multiple channels or RB sets during a COT.

As shown in FIG. 5B, in this example, the first UE 101a occupies the RB sets #j+1 to j+3 for a COT duration: slots #i to i+2. That is, the anchor RB set #j is outside these occupied RB sets. In this case, if the first UE 101a is to transmit S-SSB, the first UE 101a may perform a channel access procedure on the anchor RB set 560 outside the occupied RB sets. That is, the first UE 101a will perform the channel access procedure towards the target S-SSB occasion in a single RB set. In an example, the first UE 101a may perform Typle-1 channel access prior to the S-SSB occasion in the anchor RB set and transmit S-SSB in the S-SSB occasion if the channel is available (i.e. the above Option 1).

In addition, as similar as the case that the anchor RB set is within occupied RB sets, the first UE 101a may transmit padding data in one or more of the occupied RB sets. As shown in FIG. 5B, the first UE 101a may transmit padding data in the RB set 570 (i.e., RB set #j+2) which is in the occupied RB sets. Without any limitation, the first UE 101a may also transmit the padding data in other RB sets in the occupied RB sets. The padding data may comprise dummy data or S-SSB (i.e. the above Option 2).

The above embodiment is discussed in the case that the first UE 101a will transmit SL transmission immediately after the S-SSB occasion. Alternatively, the first 101a may transmit SL transmission immediately before the S-SSB occasion. Without any limitation, the first UE 101a may be either COT initiating UE or COT responding UE of the COT. In this disclosure, the time unit for SL transmission immediately before the S-SSB occasion is also referred to a third time unit. Similarly, based on whether the first UE 101a is enabled to occupy the first RB set in the S-SSB occasion (before the third time unit) with full RB set allocation or partial RB set allocation, the first UE 101a may perform different operations to attempt the occupancy of the S-SSB occasion. Without any limitation, the COT with RB sets distributed in a contiguous way in the frequency domain as illustrated by FIG. 5A and FIG. 5B are only for illustration purposes. The related following designs can also be applied to other cases, such as the cases that RB sets in a COT are distributed in a non-contiguous way in the frequency domain or in any other resource allocation manners with respect to the frequency domain.

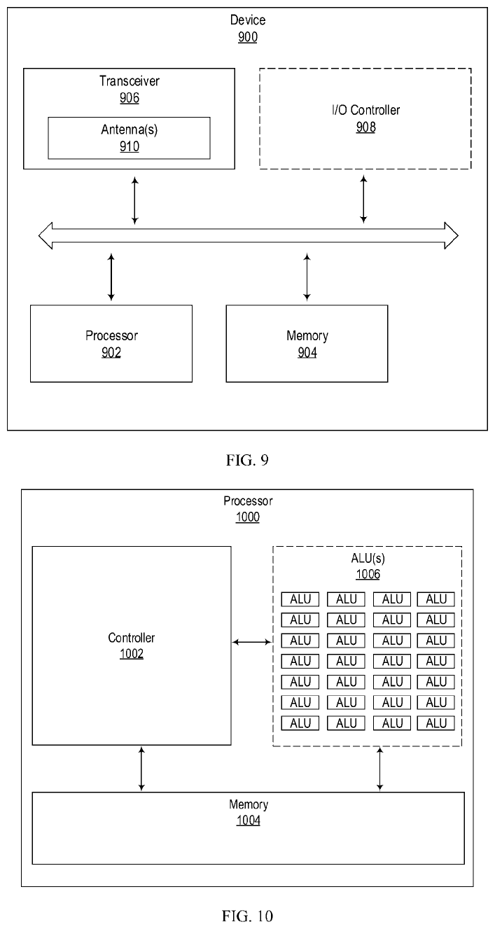

For discussion clarity, this embodiment is further discussed with reference to FIGS. 6A to 6B.

FIG. 6A illustrates a further example of associations between a COT and an SSB occasion overlapping with the COT in accordance with some example embodiments of the present disclosure.

Similarly, the first UE 101a may determine whether the user equipment occupies the first RB set (for example, anchor RB set #j as shown in FIG. 6A) in the third time unit (slot #i+1 as shown in FIG. 6A) with a full RB set resource allocation or partial RB set resource allocation. If the first UE 101a occupies this first RB set with the full RB set resource allocation, the first UE 101a may transmit a CPE before the S-SSB occasion to ensure that a gap in a second symbol 610 (for example, the symbol #13 in the third time unit) before the S-SSB occasion is not larger than 16 us. In this way, the first UE 101a may occupy the slot #i+2, i.e., the S-SSB occasion, in advance, since there is not enough time for other device to perform a Type 2 channel access procedure.

FIG. 6B illustrates a yet example of associations between a COT and an SSB occasion overlapping with the COT in accordance with some example embodiments of the present disclosure.

Similarly, the first UE 101a may determine whether the user equipment occupies the first RB set (for example, anchor RB set #j as shown in FIG. 6A) in the third time unit (slot #i+1 as shown in FIG. 6A) with a full RB set resource allocation or partial RB set resource allocation (for example, by means of one or more interlace(s) in case of interlaced-RB based waveform). If the first UE 101a occupies this first RB set with the partial RB set resource allocation, the first UE 101a may perform an LBT procedure before the S-SSB occasion (for example, in symbol 620, i.e., the symbol #13 in the third time unit).

In addition, the first UE 101a may also occupy a multiple channels for the COT duration. In some embodiments, based on whether the anchor RB set is within the multiple channels (or multiple RB sets), the first UE 101a may perform the corresponding operations in the same way as mentioned above.

Referring back to FIG. 2A, regarding the transmission power of the S-SSB, the first UE 101a may prioritize the transmission power on the anchor RB set. In some embodiments, the first UE 101a may use a first transmission power to transmit the S-SSB on the anchor RB set. The first transmission power may be configured, pre-configured, pre-defined, or defined per frequency range (FR), per bandwidth part (BWP), per carrier, per resource block (RB) set, or per resource pool (RP) configuration. In an example, the first transmission power may be received 205 via at least one of: a master information block (MIB) message, a system information block (SIB) message, a radio resource control (RRC) signaling, a medium access control (MAC) control element (CE), or downlink control information (DCI). Accordingly, the base station 130 may transmit 201 to the first UE 101a information 203 indicating the minimum number through the above signaling or configurations. For discussion clarity, the information or indication of the transmission power for S-SSB is further discussed with reference to FIG. 2B and is not further discussed here.

In addition or alternatively, the first UE 101a may use a second transmission power to transmit the S-SSB on a second number of non-anchor RB sets. Moreover, the second transmission power is determined based on the second number and a remaining transmission power other than the first transmission power. In a specific example, the first UE 101a may control the transmission power on anchor RB set and non-anchor RB set by the following steps:

The power for S-SSB transmission (e.g., denoted by P_{S-SSB}) in anchor RB set does not change due to the number of used RB sets. The motivation is to guarantee the coverage of S-SSB. For one class-2 UE performing transmission within the S-SSB occasion, the power for the transmission in non-anchor RB set within the COT can equally share a remaining power available in the UE. Given the power available for one UE in unlicensed band is denoted by P_{SL-U}: if the UE transmits S-SSB in the anchor RB set and the number of non-anchor RB sets to be transmitted in is denoted by n1, the power for each SSB on non-anchor RB set is calculated by (P_{SL-U}−P_{S-SSB})/n1; if the UE does not transmit S-SSB in the anchor RB set and the number of non-anchor RB sets to be transmitted in is denoted by n2, the power for each non-anchor RB set is calculated by P_{SL-U}/n2.

In addition, regarding the S-SSB repetition transmission, the first UE 101a may, keep the S-SSB repetitions same for anchor RB set and non-anchor RB sets. This design is beneficial for simple without introducing more configuration parameter.

In addition or alternatively, the first UE 101a transmitting the S-SSB should be the UE that initiates the COT overlapping with S-SSB occasion. For example, only the COT initiating UE will perform S-SSB transmission in S-SSB occasion(s) overlapping with the COT.

Correspondingly, with respect to the S-SSB reception, another UE (for example, the second UE 101b) selects 230, in the time unit (or S-SSB occasion), an anchor resource block (RB) set and one or more non-anchor RB sets. In some embodiments, the second UE 101b selects the anchor resource block (RB) set and one or more non-anchor RB sets by the same criterion as the first UE 101a. Without any limitation, the second UE 101b may also select the anchor resource block (RB) set and one or more non-anchor RB sets in any other manner. Then, the second UE 101b detects 250 an S-SSB 245 on at least one of the anchor RB set and the one or more non-anchor RB sets. In addition, the below embodiments regarding the S-SSB reception are provided.

For the above Option-1, if the second UE 101b attempts to receive S-SSB, the second UE 101b only needs to monitor the S-SSB occasion(s) in the anchor RB set.

For the above Option-2, if a UE attempts to receive S-SSB:
Step 1. the second UE 101b detects S-SSB in a S-SSB slot in the anchor RB set. If S-SSB is detected, then stop. Otherwise, go to step 2.
Step 2. The second UE 101b detects S-SSB in the S-SSB slot in non-anchor RB set(s). If S-SSB is detected or no S-SSB is detected in the S-SSB slot within all the non-anchor RB set(s), then stop.

With the embodiments provided in this disclosure, the coordination between S-SSB and the SL transmission in a COT overlapping with the SSB is achieved, such that the performance of the SL transmission can be enhanced.

As mentioned above, in some embodiments, the first UE 101a may receive the information of the minimum of non-RB sets and/or transmission from the base station 102. This information is further discussed with reference to FIG. 2B.

Reference is now made to FIGS. 2B, which illustrates an example signaling process 200B of a communication process that supports sidelink transmission in accordance with some example embodiments of the present disclosure. For the purpose of discussion, the process 200B will be described with reference to FIG. 1A. The process 200B may involve the first UE 101a and the BS 102. It is to be understood that the steps and the order of the steps in FIG. 2B are merely for illustration, and not for limitation. It is to be understood that process 200B may further include additional blocks not shown and/or omit some shown blocks, and the scope of the present disclosure is not limited in this regard.

As shown in FIG. 2B, the base station 102 transmits 260 information 265 indicating at least one of a minimum number of non-anchor RB set and transmission power. Correspondingly, the first UE 101a receives 270 this information 265. In some embodiments, the base station 102 may transmit information 265 indicating one of the minimum number of non-anchor RB set or transmission power. In addition or alternatively, the base station 102 may transmit information 265 indicating both of the minimum number of non-anchor RB set or transmission power.

In this way, the base station 102 may configure the minimum number and the transmission power. Furthermore, without any limitation, the minimum number and the transmission power may be also preconfigured at the first UE 101a without a specific signaling or configuration from the base station 102.

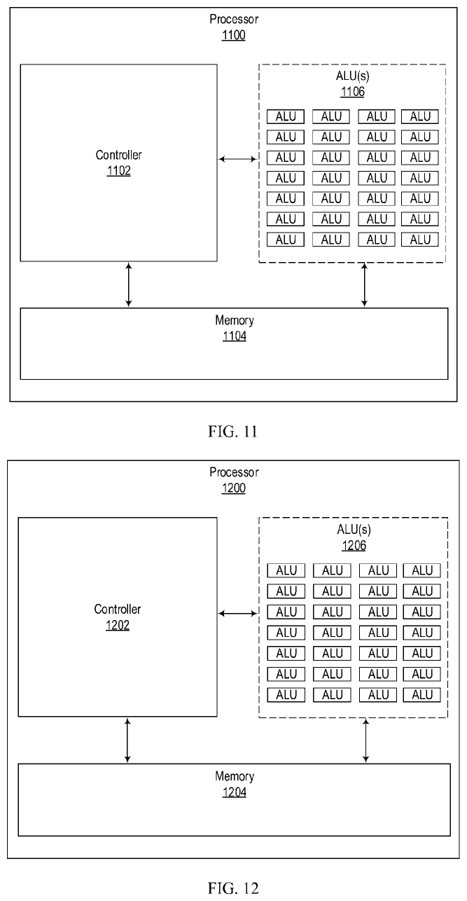

FIG. 7 illustrates an example of a device 700 that supports sidelink transmission in accordance with aspects of the present disclosure. The device 700 may be an example of a first UE 101a as described herein. The device 700 may support wireless communication with one or more network entities 102, the second UE 101b or any combination thereof. The device 700 may include components for bi-directional communications including components for transmitting and receiving communications, such as a processor 702, a memory 704, a transceiver 706, and, optionally, an I/O controller 708. These components may be in electronic communication or otherwise coupled (e.g., operatively, communicatively, functionally, electronically, electrically) via one or more interfaces (e.g., buses).

The processor 702, the memory 704, the transceiver 706, or various combinations thereof or various components thereof may be examples of means for performing various aspects of the present disclosure as described herein. For example, the processor 702, the memory 704, the transceiver 706, or various combinations or components thereof may support a method for performing one or more of the operations described herein.

In some implementations, the processor 702, the memory 704, the transceiver 706, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 702 and the memory 704 coupled with the processor 702 may be configured to perform one or more of the functions described herein (e.g., executing, by the processor 702, instructions stored in the memory 704).

For example, the processor 702 may support wireless communication at the device 700 in accordance with examples as disclosed herein. The processor 702 may be configured to operable to support means for selecting, in a time unit, an anchor resource block (RB) set and one or more non-anchor RB sets; means for performing a channel access procedure on the anchor RB set and the one or more non-anchor RB sets, and means for transmitting, via the transceiver and on at least one of the anchor RB set and the one or more non-anchor RB sets, a sidelink-synchronization signal block (S-SSB).

The processor 702 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 702 may be configured to operate a memory array using a memory controller. In some other implementations, a memory controller may be integrated into the processor 702. The processor 702 may be configured to execute computer-readable instructions stored in a memory (e.g., the memory 704) to cause the device 700 to perform various functions of the present disclosure such that the device 700 may perform any process of the disclosure as discussed with reference to FIGS. 2 to 6.

The memory 704 may include random access memory (RAM) and read-only memory (ROM). The memory 704 may store computer-readable, computer-executable code including instructions that, when executed by the processor 702 cause the device 700 to perform various functions described herein. The code may be stored in a non-transitory computer-readable medium such as system memory or another type of memory. In some implementations, the code may not be directly executable by the processor 702 but may cause a computer (e.g., when compiled and executed) to perform functions described herein. In some implementations, the memory 704 may include, among other things, a basic I/O system (BIOS) which may control basic hardware or software operation such as the interaction with peripheral components or devices.

The I/O controller 708 may manage input and output signals for the device 700. The I/O controller 708 may also manage peripherals not integrated into the device M02. In some implementations, the I/O controller 708 may represent a physical connection or port to an external peripheral. In some implementations, the I/O controller 708 may utilize an operating system such as iOS®, ANDROID®, MS-WINDOWS®, OS/2®, UNIX®, LINUX®, or another known operating system. In some implementations, the I/O controller 708 may be implemented as part of a processor, such as the processor 706. In some implementations, a user may interact with the device 700 via the I/O controller 708 or via hardware components controlled by the I/O controller 708.

In some implementations, the device 700 may include a single antenna 710. However, in some other implementations, the device 700 may have more than one antenna 710 (i.e., multiple antennas), including multiple antenna panels or antenna arrays, which may be capable of concurrently transmitting or receiving multiple wireless transmissions. The transceiver 706 may communicate bi-directionally, via the one or more antennas 710, wired, or wireless links as described herein. For example, the transceiver 706 may represent a wireless transceiver and may communicate bi-directionally with another wireless transceiver. The transceiver 706 may also include a modem to modulate the packets, to provide the modulated packets to one or more antennas 710 for transmission, and to demodulate packets received from the one or more antennas 710. The transceiver 706 may include one or more transmit chains, one or more receive chains, or a combination thereof.

A transmit chain may be configured to generate and transmit signals (e.g., control information, data, packets). The transmit chain may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmit chain may also include at least one power amplifier configured to amplify the modulated signal to an appropriate power level suitable for transmission over the wireless medium. The transmit chain may also include one or more antennas 710 for transmitting the amplified signal into the air or wireless medium.

A receive chain may be configured to receive signals (e.g., control information, data, packets) over a wireless medium. For example, the receive chain may include one or more antennas 710 for receive the signal over the air or wireless medium. The receive chain may include at least one amplifier (e.g., a low-noise amplifier (LNA)) configured to amplify the received signal. The receive chain may include at least one demodulator configured to demodulate the receive signal and obtain the transmitted data by reversing the modulation technique applied during transmission of the signal. The receive chain may include at least one decoder for decoding the processing the demodulated signal to receive the transmitted data.

FIG. 8 illustrates an example of a device 800 that supports determination of RO groups in accordance with aspects of the present disclosure. The device 800 may be an example of the second UE 101b as described herein. The device 800 may support wireless communication with one or more network entities 102, the first UE 101a, or any combination thereof. The device 800 may include components for bi-directional communications including components for transmitting and receiving communications, such as a processor 802, a memory 804, a transceiver 806, and, optionally, an I/O controller 808. These components may be in electronic communication or otherwise coupled (e.g., operatively, communicatively, functionally, electronically, electrically) via one or more interfaces (e.g., buses).

The processor 802, the memory 804, the transceiver 806, or various combinations thereof or various components thereof may be examples of means for performing various aspects of the present disclosure as described herein. For example, the processor 802, the memory 804, the transceiver 806, or various combinations or components thereof may support a method for performing one or more of the operations described herein.

In some implementations, the processor 802, the memory 804, the transceiver 806, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 802 and the memory 804 coupled with the processor 802 may be configured to perform one or more of the functions described herein (e.g., executing, by the processor 802, instructions stored in the memory 804).

For example, the processor 802 may support wireless communication at the device 800 in accordance with examples as disclosed herein. The processor 802 may be configured to operable to support means for selecting, in a time unit, an anchor resource block (RB) set and one or more non-anchor RB sets; and means for detecting, via the transceiver, on at least one of the anchor RB set and the one or more non-anchor RB sets, a sidelink-synchronization signal block (S-SSB).

The processor 802 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 802 may be configured to operate a memory array using a memory controller. In some other implementations, a memory controller may be integrated into the processor 802. The processor 802 may be configured to execute computer-readable instructions stored in a memory (e.g., the memory 804) to cause the device 800 to perform various functions of the present disclosure such that the device 800 may perform any process of the disclosure as discussed with reference to FIGS. 2 to 6.

The memory 804 may include random access memory (RAM) and read-only memory (ROM). The memory 804 may store computer-readable, computer-executable code including instructions that, when executed by the processor 802 cause the device 800 to perform various functions described herein. The code may be stored in a non-transitory computer-readable medium such as system memory or another type of memory. In some implementations, the code may not be directly executable by the processor 802 but may cause a computer (e.g., when compiled and executed) to perform functions described herein. In some implementations, the memory 804 may include, among other things, a basic I/O system (BIOS) which may control basic hardware or software operation such as the interaction with peripheral components or devices.

The I/O controller 808 may manage input and output signals for the device 800. The I/O controller 808 may also manage peripherals not integrated into the device M02. In some implementations, the I/O controller 808 may represent a physical connection or port to an external peripheral. In some implementations, the I/O controller 808 may utilize an operating system such as iOS®, ANDROID®, MS-WINDOWS®, OS/2®, UNIX®, LINUX®, or another known operating system. In some implementations, the I/O controller 808 may be implemented as part of a processor, such as the processor 806. In some implementations, a user may interact with the device 800 via the I/O controller 808 or via hardware components controlled by the I/O controller 808.

In some implementations, the device 800 may include a single antenna 810. However, in some other implementations, the device 800 may have more than one antenna 810 (i.e., multiple antennas), including multiple antenna panels or antenna arrays, which may be capable of concurrently transmitting or receiving multiple wireless transmissions. The transceiver 806 may communicate bi-directionally, via the one or more antennas 810, wired, or wireless links as described herein. For example, the transceiver 806 may represent a wireless transceiver and may communicate bi-directionally with another wireless transceiver. The transceiver 806 may also include a modem to modulate the packets, to provide the modulated packets to one or more antennas 810 for transmission, and to demodulate packets received from the one or more antennas 810. The transceiver 806 may include one or more transmit chains, one or more receive chains, or a combination thereof.

A transmit chain may be configured to generate and transmit signals (e.g., control information, data, packets). The transmit chain may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmit chain may also include at least one power amplifier configured to amplify the modulated signal to an appropriate power level suitable for transmission over the wireless medium. The transmit chain may also include one or more antennas 810 for transmitting the amplified signal into the air or wireless medium.

A receive chain may be configured to receive signals (e.g., control information, data, packets) over a wireless medium. For example, the receive chain may include one or more antennas 810 for receive the signal over the air or wireless medium. The receive chain may include at least one amplifier (e.g., a low-noise amplifier (LNA)) configured to amplify the received signal. The receive chain may include at least one demodulator configured to demodulate the receive signal and obtain the transmitted data by reversing the modulation technique applied during transmission of the signal. The receive chain may include at least one decoder for decoding the processing the demodulated signal to receive the transmitted data.

FIG. 9 illustrates an example of a device 900 that supports determination of RO groups in accordance with aspects of the present disclosure. The device 900 may be an example of the network device 102 as described herein. The device 900 may support wireless communication with one or more network entities 102, the first UE 101a, the second UE 101b, or any combination thereof. The device 900 may include components for bi-directional communications including components for transmitting and receiving communications, such as a processor 902, a memory 904, a transceiver 906, and, optionally, an I/O controller 909. These components may be in electronic communication or otherwise coupled (e.g., operatively, communicatively, functionally, electronically, electrically) via one or more interfaces (e.g., buses).

The processor 902, the memory 904, the transceiver 906, or various combinations thereof or various components thereof may be examples of means for performing various aspects of the present disclosure as described herein. For example, the processor 902, the memory 904, the transceiver 906, or various combinations or components thereof may support a method for performing one or more of the operations described herein.

In some implementations, the processor 902, the memory 904, the transceiver 906, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 902 and the memory 904 coupled with the processor 902 may be configured to perform one or more of the functions described herein (e.g., executing, by the processor 902, instructions stored in the memory 904).

For example, the processor 902 may support wireless communication at the device 900 in accordance with examples as disclosed herein. The processor 902 may be configured to operable to support means for transmitting, to a user equipment, information indicating at least one of: a minimum number of non-anchor resource block (RB) sets associated with a transmission of a sidelink-synchronization signal block (S-SSB), or a transmission power of the S-SSB on an anchor RB set.

The processor 902 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 902 may be configured to operate a memory array using a memory controller. In some other implementations, a memory controller may be integrated into the processor 902. The processor 902 may be configured to execute computer-readable instructions stored in a memory (e.g., the memory 904) to cause the device 900 to perform various functions of the present disclosure such that the device 900 may perform any process of the disclosure as discussed with reference to FIGS. 2 to 6.

The memory 904 may include random access memory (RAM) and read-only memory (ROM). The memory 904 may store computer-readable, computer-executable code including instructions that, when executed by the processor 902 cause the device 900 to perform various functions described herein. The code may be stored in a non-transitory computer-readable medium such as system memory or another type of memory. In some implementations, the code may not be directly executable by the processor 902 but may cause a computer (e.g., when compiled and executed) to perform functions described herein. In some implementations, the memory 904 may include, among other things, a basic I/O system (BIOS) which may control basic hardware or software operation such as the interaction with peripheral components or devices.

The I/O controller 909 may manage input and output signals for the device 900. The I/O controller 909 may also manage peripherals not integrated into the device M02. In some implementations, the I/O controller 909 may represent a physical connection or port to an external peripheral. In some implementations, the I/O controller 909 may utilize an operating system such as iOS®, ANDROID®, MS-WINDOWS®, OS/2®, UNIX®, LINUX®, or another known operating system. In some implementations, the I/O controller 909 may be implemented as part of a processor, such as the processor 906. In some implementations, a user may interact with the device 900 via the I/O controller 909 or via hardware components controlled by the I/O controller 909.

In some implementations, the device 900 may include a single antenna 910. However, in some other implementations, the device 900 may have more than one antenna 910 (i.e., multiple antennas), including multiple antenna panels or antenna arrays, which may be capable of concurrently transmitting or receiving multiple wireless transmissions. The transceiver 906 may communicate bi-directionally, via the one or more antennas 910, wired, or wireless links as described herein. For example, the transceiver 906 may represent a wireless transceiver and may communicate bi-directionally with another wireless transceiver. The transceiver 906 may also include a modem to modulate the packets, to provide the modulated packets to one or more antennas 910 for transmission, and to demodulate packets received from the one or more antennas 910. The transceiver 906 may include one or more transmit chains, one or more receive chains, or a combination thereof.

A transmit chain may be configured to generate and transmit signals (e.g., control information, data, packets). The transmit chain may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmit chain may also include at least one power amplifier configured to amplify the modulated signal to an appropriate power level suitable for transmission over the wireless medium. The transmit chain may also include one or more antennas 910 for transmitting the amplified signal into the air or wireless medium.

A receive chain may be configured to receive signals (e.g., control information, data, packets) over a wireless medium. For example, the receive chain may include one or more antennas 910 for receive the signal over the air or wireless medium. The receive chain may include at least one amplifier (e.g., a low-noise amplifier (LNA)) configured to amplify the received signal. The receive chain may include at least one demodulator configured to demodulate the receive signal and obtain the transmitted data by reversing the modulation technique applied during transmission of the signal. The receive chain may include at least one decoder for decoding the processing the demodulated signal to receive the transmitted data.

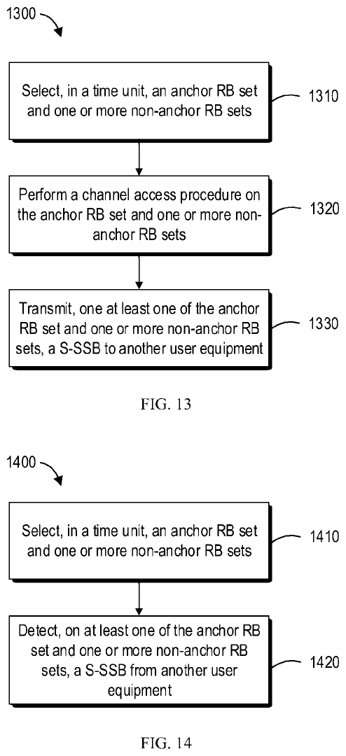

FIG. 10 illustrates an example of a processor 1000 that supports sidelink transmission in accordance with aspects of the present disclosure. The processor 1000 may be an example of a processor configured to perform various operations in accordance with examples as described herein. The processor 1000 may be implemented in a device or its components as described herein. For example, the device may be an example of the first UE 101 as described herein. The processor 1000 may include a controller 1002 configured to perform various operations in accordance with examples as described herein. The processor 1000 may optionally include at least one memory 1004, such as L1/L2/L3 cache. Additionally, or alternatively, the processor 1000 may optionally include one or more arithmetic-logic units (ALUs) 1000. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory address of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, arithmetic logic units (ALUs), and other functional units of the processor 1000.

The memory 1004 may include one or more caches (e.g., memory local to or included in the processor 1000 or other memory, such RAM, ROM, DRAM, SDRAM, SRAM, MRAM, flash memory, etc. In some implementation, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, and the processor 1000, the controller 1002, and the memory 1004 may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1000 may be configured to support various operations in accordance with examples as described herein. In some implementation, the one or more ALUs 1000 may reside within or on a processor chipset (e.g., the processor 1000). In some other implementations, the one or more ALUs 1000 may reside external to the processor chipset (e.g., the processor 1000). One or more ALUs 1000 may perform one or more computations such as addition, subtraction, multiplication, and division on data. For example, one or more ALUs 1000 may receive input operands and an operation code, which determines an operation to be executed. One or more ALUs 1000 be configured with a variety of logical and arithmetic circuits, including adders, subtractors, shifters, and logic gates, to process and manipulate the data according to the operation. Additionally, or alternatively, the one or more ALUs 1000 may support logical operations such as AND, OR, exclusive-OR (XOR), not-OR (NOR), and not-AND (NAND), enabling the one or more ALUs 1000 to handle conditional operations, comparisons, and bitwise operations.

The processor 1000 may support wireless communication in accordance with examples as disclosed herein. The processor 1000 may be configured to or operable to support means for selecting, in a time unit, an anchor resource block (RB) set and one or more non-anchor RB sets; means for performing a channel access procedure on the anchor RB set and the one or more non-anchor RB sets, and means for transmitting, via the transceiver and on at least one of the anchor RB set and the one or more non-anchor RB sets, a sidelink-synchronization signal block (S-SSB).

FIG. 11 illustrates an example of a processor 1100 that supports determination of RO groups in accordance with aspects of the present disclosure. The processor 1100 may be an example of a processor configured to perform various operations in accordance with examples as described herein. The processor 1100 may be implemented in a device or its components as described herein. For example, the device may be an example of the second UE 102a as described herein. The processor 1100 may include a controller 1102 configured to perform various operations in accordance with examples as described herein. The processor 1100 may optionally include at least one memory 1101, such as L1/L2/L3 cache. Additionally, or alternatively, the processor 1100 may optionally include one or more arithmetic-logic units (ALUs) 1100. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1101 and determine subsequent instruction(s) to be executed to cause the processor 1100 to support various operations in accordance with examples as described herein. The controller 1102 may be configured to track memory address of instructions associated with the memory 1101. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, arithmetic logic units (ALUs), and other functional units of the processor 1100.

The memory 1101 may include one or more caches (e.g., memory local to or included in the processor 1100 or other memory, such RAM, ROM, DRAM, SDRAM, SRAM, MRAM, flash memory, etc. In some implementation, the memory 1101 may reside within or on a processor chipset (e.g., local to the processor 1100). In some other implementations, the memory 1101 may reside external to the processor chipset (e.g., remote to the processor 1100).

The memory 1101 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1101 to cause the processor 1100 to perform various functions. For example, the processor 1100 and/or the controller 1102 may be coupled with or to the memory 1101, and the processor 1100, the controller 1102, and the memory 1101 may be configured to perform various functions described herein. In some examples, the processor 1100 may include multiple processors and the memory 1101 may include multiple memories. One or more of the multiple processors may be coupled with one or more of the multiple memories, which may, individually or collectively, be configured to perform various functions herein.

The one or more ALUs 1100 may be configured to support various operations in accordance with examples as described herein. In some implementation, the one or more ALUs 1100 may reside within or on a processor chipset (e.g., the processor 1100). In some other implementations, the one or more ALUs 1100 may reside external to the processor chipset (e.g., the processor 1100). One or more ALUs 1100 may perform one or more computations such as addition, subtraction, multiplication, and division on data. For example, one or more ALUs 1100 may receive input operands and an operation code, which determines an operation to be executed. One or more ALUs 1100 be configured with a variety of logical and arithmetic circuits, including adders, subtractors, shifters, and logic gates, to process and manipulate the data according to the operation. Additionally, or alternatively, the one or more ALUs 1100 may support logical operations such as AND, OR, exclusive-OR (XOR), not-OR (NOR), and not-AND (NAND), enabling the one or more ALUs 1100 to handle conditional operations, comparisons, and bitwise operations.

The processor 1100 may support wireless communication in accordance with examples as disclosed herein. The processor 1100 may be configured to or operable to support means for selecting, in a time unit, an anchor resource block (RB) set and one or more non-anchor RB sets; and means for detecting, via the transceiver, on at least one of the anchor RB set and the one or more non-anchor RB sets, a sidelink-synchronization signal block (S-SSB).

FIG. 12 illustrates an example of a processor 1200 that supports determination of RO groups in accordance with aspects of the present disclosure. The processor 1200 may be an example of a processor configured to perform various operations in accordance with examples as described herein. The processor 1200 may be implemented in a device or its components as described herein. For example, the device may be an example of a base station 102 as described herein. The processor 1200 may include a controller 1202 configured to perform various operations in accordance with examples as described herein. The processor 1200 may optionally include at least one memory 1204, such as L1/L2/L3 cache. Additionally, or alternatively, the processor 1200 may optionally include one or more arithmetic-logic units (ALUs) 1200. One or more of these components may be in electronic communication or otherwise coupled (e.g., operatively, communicatively, functionally, electronically, electrically) via one or more interfaces (e.g., buses).

The processor 1200 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1200) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1202 may be configured to manage and coordinate various operations (e.g., signaling, receiving, obtaining, retrieving, transmitting, outputting, forwarding, storing, determining, identifying, accessing, writing, reading) of the processor 1200 to cause the processor 1200 to support various operations in accordance with examples as described herein. For example, the controller 1202 may operate as a control unit of the processor 1200, generating control signals that manage the operation of various components of the processor 1200. These control signals include enabling or disabling functional units, selecting data paths, initiating memory access, and coordinating timing of operations.

The controller 1202 may be configured to fetch (e.g., obtain, retrieve, receive) instructions from the memory 1204 and determine subsequent instruction(s) to be executed to cause the processor 1200 to support various operations in accordance with examples as described herein. The controller 1202 may be configured to track memory address of instructions associated with the memory 1204. The controller 1202 may be configured to decode instructions to determine the operation to be performed and the operands involved. For example, the controller 1202 may be configured to interpret the instruction and determine control signals to be output to other components of the processor 1200 to cause the processor 1200 to support various operations in accordance with examples as described herein. Additionally, or alternatively, the controller 1202 may be configured to manage flow of data within the processor 1200. The controller 1202 may be configured to control transfer of data between registers, arithmetic logic units (ALUs), and other functional units of the processor 1200.

The memory 1204 may include one or more caches (e.g., memory local to or included in the processor 1200 or other memory, such RAM, ROM, DRAM, SDRAM, SRAM, MRAM, flash memory, etc. In some implementation, the memory 1204 may reside within or on a processor chipset (e.g., local to the processor 1200). In some other implementations, the memory 1204 may reside external to the processor chipset (e.g., remote to the processor 1200).

The memory 1204 may store computer-readable, computer-executable code including instructions that, when executed by the processor 1200, cause the processor 1200 to perform various functions described herein. The code may be stored in a non-transitory computer-readable medium such as system memory or another type of memory. The controller 1202 and/or the processor 1200 may be configured to execute computer-readable instructions stored in the memory 1204 to cause the processor 1200 to perform various functions. For example, the processor 1200 and/or the controller 1202 may be coupled with or to the memory 1204, and the processor 1200, the controller 1202, and the memory 1204 may be configured to perform various functions described herein. In some examples, the processor 1200 may include multiple processors and the memory 1204 may include multiple memories. One or more of the multiple processors may be coupled with one or more of the multiple memories, which may, individually or collectively, be configured to perform various functions herein.

The one or more ALUs 1200 may be configured to support various operations in accordance with examples as described herein. In some implementation, the one or more ALUs 1200 may reside within or on a processor chipset (e.g., the processor 1200). In some other implementations, the one or more ALUs 1200 may reside external to the processor chipset (e.g., the processor 1200). One or more ALUs 1200 may perform one or more computations such as addition, subtraction, multiplication, and division on data. For example, one or more ALUs 1200 may receive input operands and an operation code, which determines an operation to be executed. One or more ALUs 1200 be configured with a variety of logical and arithmetic circuits, including adders, subtractors, shifters, and logic gates, to process and manipulate the data according to the operation. Additionally, or alternatively, the one or more ALUs 1200 may support logical operations such as AND, OR, exclusive-OR (XOR), not-OR (NOR), and not-AND (NAND), enabling the one or more ALUs 1200 to handle conditional operations, comparisons, and bitwise operations.

The processor 1200 may support wireless communication in accordance with examples as disclosed herein. The processor 1200 may be configured to or operable to support means for transmitting, to a user equipment, information indicating at least one of: a minimum number of non-anchor resource block (RB) sets associated with a transmission of a sidelink-synchronization signal block (S-SSB), or a transmission power of the S-SSB on an anchor RB set.

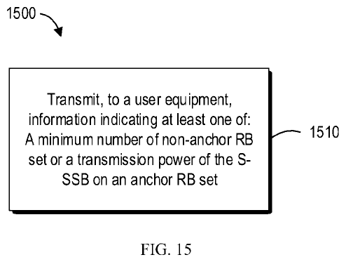

FIG. 13 illustrates a flowchart of a method 1300 that supports sidelink transmission in accordance with aspects of the present disclosure. The operations of the method 1300 may be implemented by a device or its components as described herein. For example, the operations of the method 1300 may be performed by the first UE 101a as described herein. In some implementations, the device may execute a set of instructions to control the function elements of the device to perform the described functions. Additionally, or alternatively, the device may perform aspects of the described functions using special-purpose hardware.

At 1310, the method may include selecting, in a time unit, an anchor resource block (RB) set and one or more non-anchor RB sets. At 1320, the method may include performing a channel access procedure on the anchor RB set and the one or more non-anchor RB sets. At 1330, the method include transmitting, on at least one of the anchor RB set and one or more non-anchor RB sets, a sidelink-synchronization signal block (S-SSB). The operations of 1310, 1320 and 1330 may be performed in accordance with examples as described herein. In some implementations, aspects of the operations of 1310, 1320 and 1330 may be performed by a device as described with reference to FIG. 1A.

FIG. 14 illustrates a flowchart of a method 1400 that supports sidelink transmission in accordance with aspects of the present disclosure. The operations of the method 1400 may be implemented by a device or its components as described herein. For example, the operations of the method 1200 may be performed by the second UE 101b as described herein. In some implementations, the device may execute a set of instructions to control the function elements of the device to perform the described functions. Additionally, or alternatively, the device may perform aspects of the described functions using special-purpose hardware.

At 1410, the method may include selecting, in a time unit, an anchor resource block (RB) set and one or more non-anchor RB sets. At 1420, the method may include detecting, on at least one of the anchor RB set and the one or more non-anchor RB sets, a sidelink-synchronization signal block (S-SSB). The operations of 1410 and 1420 may be performed in accordance with examples as described herein. In some implementations, aspects of the operations of 1410 and 1420 may be performed by a device as described with reference to FIG. 1A.

FIG. 15 illustrates a flowchart of a method 1500 that supports sidelink transmission in accordance with aspects of the present disclosure. The operations of the method 1500 may be implemented by a device or its components as described herein. For example, the operations of the method 1500 may be performed by a network entity 102 as described herein. In some implementations, the device may execute a set of instructions to control the function elements of the device to perform the described functions. Additionally, or alternatively, the device may perform aspects of the described functions using special-purpose hardware.

At 1510, the method may include transmitting, to a user equipment, information indicating at least one of a minimum number of non-anchor resource block (RB) sets associated with a transmission of a sidelink-synchronization signal block (S-SSB), or a transmission power of the S-SSB on an anchor RB set. The operations of 1510 may be performed in accordance with examples as described herein. In some implementations, aspects of the operations of 1510 may be performed by a device as described with reference to FIG. 1A.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

In summary, embodiments of the present disclosure may provide the following solutions.

Clause 1. A user equipment comprising: a processor; and a transceiver coupled to the processor, wherein the processor is configured to: select, in a time unit, an anchor resource block (RB) set and one or more non-anchor RB sets; perform a channel access procedure on the anchor RB set and the one or more non-anchor RB sets; and transmit, via the transceiver and on at least one of the anchor RB set and the one or more non-anchor RB sets, a sidelink-synchronization signal block (S-SSB).

Clause 2. The user equipment of clause 1, wherein selecting the anchor RB set and the one or more non-anchor RB sets comprises: selecting the anchor RB set and a first number of non-anchor RB sets, wherein the first number is equal to or greater than a minimum number, and wherein the minimum number is obtained based on pre-configuration or configuration.

Clause 3. The user equipment of clause 1, wherein transmitting the S-SSB comprises: determining whether the anchor RB set is available based on the channel access procedure; and based on determining that the anchor RB set is available, transmitting the S-SSB on the anchor RB set.

Clause 4. The user equipment of clause 3, wherein transmitting the S-SSB comprises: based on determining that the anchor RB set is unavailable, determining whether the one or more non-anchor RB sets are available based on the channel access procedure; and based on determining that a non-anchor RB set is available, transmitting the S-SSB on the non-anchor RB set.

Clause 5. The user equipment of clause 4, wherein transmitting the S-SSB comprises: based on determining that a plurality of non-anchor RB sets are available, selecting a non-anchor RB set from the plurality of non-anchor RB sets; and transmitting, via the transceiver, the S-SSB on the selected non-anchor RB set.

Clause 6. The user equipment of clause 5, wherein selecting the non-anchor RB set from the plurality of non-anchor RB sets comprises: selecting the non-anchor RB set randomly; or selecting the non-anchor RB set based on an index of the non-anchor RB set among the plurality of non-anchor RB sets.

Clause 7. The user equipment of clause 1, wherein the time unit is one of a plurality of time units that are included in a channel occupancy time (COT), and wherein the processor is further caused to: obtain COT information that is associated with the COT.

Clause 8. The user equipment of clause 7, wherein the at least one of the anchor RB set and the one or more non-anchor RB sets comprises a first RB set, wherein the user equipment is configured to use the first RB set in a second time unit in the COT and the second time unit is after the time unit, and the processor is further configured to: determine whether the user equipment occupies the first RB set in the second time unit with a full RB set resource allocation or partial RB set resource allocation; based on determining that the user equipment occupies the first RB set with the full RB set resource allocation, transmit a cyclic prefix extension (CPE) before the second time unit; and based on determining that the user equipment occupies the first RB set with the partial RB set resource allocation, perform a listen before talk (LBT) procedure before the second time unit.

Clause 9. The user equipment of clause 7, wherein the at least one of the anchor RB set and the one or more non-anchor RB sets comprises a first RB set, wherein the user equipment is configured to use the first RB set in a third time unit in the COT and the third time unit is before the time unit, and the processor is further caused to: determine whether the user equipment occupies the first RB set in the third time unit with a full RB set resource allocation or partial RB set resource allocation; based on determining that the user equipment occupies the first RB set with the full RB set resource allocation, transmit a CPE before the time unit; and based on determining that the user equipment occupies the first RB set with the partial RB set resource allocation, perform an LBT procedure before the second time unit.

Clause 10. The user equipment of clause 8 or 9, wherein transmitting the CPE comprises: transmitting the CPE to ensure that a gap in a first symbol before the second time unit or in a second symbol before the time unit is smaller than 16 us.

Clause 11. The user equipment of clause 7, wherein the COT is initiated by the user equipment.

Clause 12. The user equipment of clause 1, wherein the user equipment is configured to occupy a plurality of RB sets in a COT, and the processor is further configured to: determine whether the anchor RB set is one of the plurality of RB sets; and

based on determining that the anchor RB set is one of the plurality of RB sets, transmit: i) the S-SSB on the anchor RB set and padding data on at least one non-anchor RB set of the plurality of RB sets, or ii) the S-SSB on the at least one non-anchor RB set of the plurality of RB sets.

Clause 13. The user equipment of clause 1, wherein the user equipment is configured to occupy a plurality of RB sets in a COT, and the processor is further configured to: determine whether the anchor RB set is one of the plurality of RB sets; perform, in response that the user equipment is to transmit S-SSB, a channel access procedure on the anchor RB set based on determining that the anchor RB set is not one of the plurality of RB sets; transmit, via the transceiver, the S-SSB on the anchor RB set; and transmit, via the transceiver: i) padding data on at least one non-anchor RB set of the plurality of RB sets, or ii) the S-SSB on the at least one non-anchor RB set of the plurality of RB sets.

Clause 14. The user equipment of clause 1, wherein transmitting the S-SSB comprises: transmitting, via the transceiver and using a first transmission power, the S-SSB on the anchor RB set, wherein the first transmission power is obtained based on pre-configuration or configuration; and

Clause 15. The user equipment of clause 14, wherein transmitting, via the transceiver and using a second transmission power, the S-SSB on a second number of non-anchor RB sets, wherein the second transmission power is determined based on the second number and a remaining transmission power other than the first transmission power.

Clause 16. A user equipment comprising: a processor; and a transceiver coupled to the processor, wherein the processor is configured to: select, in a time unit, an anchor resource block (RB) set and one or more non-anchor RB sets; and detect, via the transceiver, on at least one of the anchor RB set and the one or more non-anchor RB sets, a sidelink-synchronization signal block (S-SSB).

Clause 17. A base station comprising: a processor; and a transceiver coupled to the processor, wherein the processor is configured to: transmit, to a user equipment, information indicating at least one of: a minimum number of non-anchor resource block (RB) sets associated with a transmission of a sidelink-synchronization signal block (S-SSB), or a transmission power of the S-SSB on an anchor RB set.

Clause 18. A processor for communication, comprising: at least one memory; and a controller coupled with the at least one memory and configured to cause the controller to: select, in a time unit, an anchor resource block (RB) set and the one or more non-anchor RB sets; perform a channel access procedure on the anchor RB set and one or more non-anchor RB sets; and transmit, on at least one of the anchor RB set and one or more non-anchor RB sets, a sidelink-synchronization signal block (S-SSB).

Clause 19. A processor for communication, comprising: at least one memory; and a controller coupled with the at least one memory and configured to cause the controller to: select, in a time unit, an anchor resource block (RB) set and the one or more non-anchor RB sets; and detect, on at least one of the anchor RB set and one or more non-anchor RB sets, a sidelink-synchronization signal block (S-SSB).

Clause 20. A processor for communication, comprising: at least one memory; and a controller coupled with the at least one memory and configured to cause the controller to: transmit, to a user equipment, information indicating at least one of: a minimum number of non-anchor resource block (RB) sets associated with a transmission of a sidelink-synchronization signal block (S-SSB), or a transmission power of the S-SSB on an anchor RB set.

Clause 21. A method performed by a user equipment, the method comprising: selecting, in a time unit, an anchor resource block (RB) set and one or more non-anchor RB sets; performing a channel access procedure on the anchor RB set and the one or more non-anchor RB sets; and transmitting, on at least one of the anchor RB set and one or more non-anchor RB sets, a sidelink-synchronization signal block (S-SSB).

Clause 22. A method performed by a user equipment, the method comprising: selecting, in a time unit, an anchor resource block (RB) set and one or more non-anchor RB sets; and detecting, on at least one of the anchor RB set and the one or more non-anchor RB sets, a sidelink-synchronization signal block (S-SSB).

Clause 23. A method performed by a base station, the method comprising: transmit, to a user equipment, information indicating at least one of: a minimum number of non-anchor resource block (RB) sets associated with a transmission of a sidelink-synchronization signal block (S-SSB), or a transmission power of the S-SSB on an anchor RB set.

Clause 24. A computer readable medium having instructions stored thereon, the instructions, when executed on at least one processor, causing the at least one processor to perform the method according to any of clauses 21-23.

1. A user equipment (UE) comprising:
at least one memory; and
at least one processor coupled with the at least one memory and configured to cause the UE to:
select, in a time unit, an anchor resource block (RB) set and one or more non-anchor RB sets;
perform a channel access procedure on the anchor RB set and the one or more non-anchor RB sets; and
transmit, on at least one of the anchor RB set and the one or more non-anchor RB sets, a sidelink-synchronization signal block (S-SSB).

2. The UE of claim 1, wherein selecting the anchor RB set and the one or more non-anchor RB sets comprises:
selecting the anchor RB set and a first number of non-anchor RB sets, wherein the first number is equal to or greater than a minimum number, and wherein the minimum number is obtained based on pre-configuration or configuration.

3. The UE of claim 1, wherein transmitting the S-SSB comprises:
determining whether the anchor RB set is available based on the channel access procedure; and
based on determining that the anchor RB set is available, transmitting the S-SSB on the anchor RB set.

4. The UE of claim 3, wherein transmitting the S-SSB comprises:
based on determining that the anchor RB set is unavailable, determining whether the one or more non-anchor RB sets are available based on the channel access procedure; and
based on determining that a non-anchor RB set is available, transmitting the S-SSB on the non-anchor RB set.

5. The UE of claim 4, wherein transmitting the S-SSB comprises:
based on determining that a plurality of non-anchor RB sets are available, selecting a non-anchor RB set from the plurality of non-anchor RB sets; and
transmitting, the S-SSB on the selected non-anchor RB set.

6. The UE of claim 5, wherein selecting the non-anchor RB set from the plurality of non-anchor RB sets comprises:
selecting the non-anchor RB set randomly; or
selecting the non-anchor RB set based on an index of the non-anchor RB set among the plurality of non-anchor RB sets.

7. The UE of claim 1, wherein the time unit is one of a plurality of time units that are included in a channel occupancy time (COT), and wherein the at least one processor is configured to cause the UE to:
obtain COT information that is associated with the COT.

8. The UE of claim 7, wherein the at least one of the anchor RB set and the one or more non-anchor RB sets comprises a first RB set, wherein the user equipment is configured to use the first RB set in a second time unit in the COT and the second time unit is after the time unit, and the at least one processor is configured to cause the UE to:
determine whether the UE occupies the first RB set in the second time unit with a full RB set resource allocation or partial RB set resource allocation;
based on determining that the UE occupies the first RB set with the full RB set resource allocation, transmit a cyclic prefix extension (CPE) before the second time unit; and
based on determining that the UE occupies the first RB set with the partial RB set resource allocation, perform a listen before talk (LBT) procedure before the second time unit.

9. The UE of claim 7, wherein the at least one of the anchor RB set and the one or more non-anchor RB sets comprises a first RB set, wherein the UE is configured to use the first RB set in a third time unit in the COT and the third time unit is before the time unit, and
the at least one processor is configured to cause the UE to:
determine whether the user equipment occupies the first RB set in the third time unit with a full RB set resource allocation or partial RB set resource allocation;
based on determining that the user equipment occupies the first RB set with the full RB set resource allocation, transmit a CPE before the time unit; and
based on determining that the user equipment occupies the first RB set with the partial RB set resource allocation, perform an LBT procedure before a second time unit.

10. The UE of claim 8, wherein transmitting the CPE comprises:
transmitting the CPE to ensure that a gap in a first symbol before the second time unit or in a second symbol before the time unit is smaller than 16 us.

11. The UE of claim 7, wherein the COT is initiated by the UE.

12. The UE of claim 1, wherein the UE is configured to occupy a plurality of RB sets in a COT, and the at least one processor is configured to cause the UE to:
determine whether the anchor RB set is one of the plurality of RB sets; and
based on determining that the anchor RB set is one of the plurality of RB sets, transmit: i) the S-SSB on the anchor RB set and padding data on at least one non-anchor RB set of the plurality of RB sets, or ii) the S-SSB on the at least one non-anchor RB set of the plurality of RB sets.

13. The UE of claim 1, wherein the UE is configured to occupy a plurality of RB sets in a COT, and the at least one processor is configured to cause the UE to:
determine whether the anchor RB set is one of the plurality of RB sets;
perform, in response that the UE is to transmit S-SSB, a channel access procedure on the anchor RB set based on determining that the anchor RB set is not one of the plurality of RB sets;
transmit the S-SSB on the anchor RB set; and
transmit: i) padding data on at least one non-anchor RB set of the plurality of RB sets, or ii) the S-SSB on the at least one non-anchor RB set of the plurality of RB sets.

14. The UE of claim 1, wherein transmitting the S-SSB comprises:
transmitting, using a first transmission power, the S-SSB on the anchor RB set, wherein the first transmission power is obtained based on pre-configuration or configuration.

15. The UE of claim 14, wherein the at least one processor is configured to cause the UE to transmit, using a second transmission power, the S-SSB on a second number of non-anchor RB sets, wherein the second transmission power is determined based on the second number and a remaining transmission power other than the first transmission power.

16. A user equipment (UE), comprising:
at least one memory; and
at least one processor coupled with the at least one memory and configured to cause the UE to:
select, in a time unit, an anchor resource block (RB) set and one or more non-anchor RB sets; and
detect on at least one of the anchor RB set and the one or more non-anchor RB sets, a sidelink-synchronization signal block (S-SSB).

17. A base station, comprising:
at least one memory; and
at least one processor coupled with the at least one memory and configured to cause the base station to:
transmit, to a user equipment-(UE), information indicating at least one of:
a minimum number of non-anchor resource block (RB) sets associated with a transmission of a sidelink-synchronization signal block (S-SSB), or
a transmission power of the S-SSB on an anchor RB set.

18. (canceled)

19. A method performed by a user equipment-(UE), the method comprising:
selecting, in a time unit, an anchor resource block (RB) set and one or more non-anchor RB sets;
performing a channel access procedure on the anchor RB set and the one or more non-anchor RB sets; and
transmitting, on at least one of the anchor RB set and one or more non-anchor RB sets, a sidelink-synchronization signal block (S-SSB).

20. (canceled)

21. The method of claim 19, wherein selecting the anchor RB set and the one or more non-anchor RB sets comprises:
selecting the anchor RB set and a first number of non-anchor RB sets, wherein the first number is equal to or greater than a minimum number, and wherein the minimum number is obtained based on pre-configuration or configuration.

22. The method of claim 19, wherein transmitting the S-SSB comprises:
determining whether the anchor RB set is available based on the channel access procedure; and
based on determining that the anchor RB set is available, transmitting the S-SSB on the anchor RB set.
